(19) United States
(12) Patent Application Publication
(10) Pub. No.: US 2025/0208387 A1
(43) Pub. Date: Jun. 26, 2025

(54) IMAGING OPTICAL SYSTEM

(71) Applicant: SIGMA CORPORATION, Kanagawa (JP)

(72) Inventors: Yukihiro YAMAMOTO, Tokyo (JP); Ken ASAKURA, Kanagawa (JP); Noriyuki OGASAWARA, Tokyo (JP)

(73) Assignee: SIGMA CORPORATION, Kanagawa (JP)

(21) Appl. No.: 18/971,487

(22) Filed: Dec. 6, 2024

(30) Foreign Application Priority Data
Dec. 26, 2023 (JP) 2023-219296

(51) Int. Cl. G02B 15/14; G02B 15/22

(52) U.S. Cl. CPC G02B 15/143101; G02B 15/22

(57) ABSTRACT

An object of the present invention is to provide an imaging optical system that is inherently small and lightweight, and suitable for use in a small and lightweight telephoto lens with a small and lightweight focusing unit.

The imaging optical system of the present invention includes, in order from an object side to an image side: a first group G1 with positive power overall; a second group G2 composed of a lens that moves along an optical axis during focusing; and a third group G3 with power. The imaging optical system satisfies a specified conditional expression.

### FIELD OF THE INVENTION

The present invention relates to an imaging optical system suitable for use in photographing lenses for still cameras, video cameras, and the like.

### BACKGROUND ART

Conventionally, telephoto-type imaging optical systems have been known as imaging optical systems suitable for use in long focal length photographing lenses (hereinafter referred to as telephoto lenses), which have, in order from the object side to the image side, a lens group with positive power and a lens group with negative power. By employing a telephoto-type power arrangement, it becomes possible to shorten the total lens length of telephoto lenses, which are likely to be long and heavy.

Furthermore, telephoto lenses are often used for photographing sports, animals, and the like, and require high-speed autofocus. If telephoto lenses employ a full-extension system that moves the entire imaging optical system for focusing, the weight of the lenses that move during focusing increases, making it difficult to achieve high-speed autofocus. Therefore, telephoto lenses often employ an inner focus system.

Moreover, in recent years, telephoto lenses have been increasingly used for photographing moving images. When used for photographing moving images, telephoto lenses often use a contrast detection system for autofocus. In the contrast detection system, the focusing unit is generally caused to perform a wobbling operation to detect contrast. Therefore, there has been a demand for telephoto lenses equipped with a lighter focusing unit than before.

In addition, in recent years, with the widespread use of small mirrorless cameras, there has been a demand for downsizing and weight reduction of telephoto lenses. For downsizing and weight reduction of telephoto lenses, it is important to not only downsize the imaging optical system but also reduce the sizes and weights of the movable units. This is because the size or arrangement of the actuator is affected by the sizes or weights of the movable units.

### SUMMARY OF THE INVENTION

The imaging optical system described in Japanese Patent No. 6627313 achieves high performance while employing an inner focus system, but the downsizing and weight reduction of the focusing unit are insufficient. Furthermore, the total lens length relative to the focal length is not sufficiently small.

The present invention has been made in view of the above circumstances, and its object is to provide an imaging optical system that is inherently small and lightweight, and suitable for use in a small and lightweight telephoto lens with a small and lightweight focusing unit.

In order to achieve the above object, the present invention provides an imaging optical system including, in order from an object side to an image side: a first group G1 with positive power overall; a second group G2 composed of a lens that moves along an optical axis during focusing; and a third group G3 with power, wherein the first group G1 is composed, in order from the object side to the image side, of a first a group G1a, a plurality of lenses, and a first b group G1b, the first a group G1a has, in order from the most object side, at least two positive lenses and a meniscus-shaped negative lens with a convex surface thereof facing the object side on the most image side, the first b group G1b has, on the most object side, a positive lens or a lens component including a positive lens on the most image side within the first group G1, an air distance D_A11, which is the longest within the first group G1, is provided between the first a group G1a and the first b group G1b, and

the imaging optical system satisfies a following conditional expression:

0.05<D_A11/D_G1<0.44, (1)
where
D_A11 represents the longest air distance within the first group G1, and
D_G1 represents a distance on the optical axis from an object-side lens surface of a lens arranged on the most object side to an image-side lens surface of a lens arranged on the most image side within the first group G1.

According to the present invention, it is possible to provide an imaging optical system that is inherently small and lightweight, and suitable for use in a small and lightweight telephoto lens with a small and lightweight focusing unit.

### BRIEF DESCRIPTION OF THE DRAWINGS

FIG. 1 is a lens configuration diagram at infinity according to a first embodiment of the present invention;

FIG. 2 is a longitudinal aberration diagram at infinity according to the first embodiment of the present invention;

FIG. 3 is a longitudinal aberration diagram at a focusing distance of 3.2 m according to the first embodiment of the present invention;

FIG. 4 is a lateral aberration diagram at infinity according to the first embodiment of the present invention;

FIG. 5 is a lateral aberration diagram at a focusing distance of 3.2 m according to the first embodiment of the present invention;

FIG. 6 is a lateral aberration diagram with vibration reduction of 0.3° at infinity according to the first embodiment of the present invention;

FIG. 7 is a lens configuration diagram at infinity according to a second embodiment of the present invention;

FIG. 8 is a longitudinal aberration diagram at infinity according to the second embodiment of the present invention;

FIG. 9 is a longitudinal aberration diagram at a focusing distance of 3.3 m according to the second embodiment of the present invention;

FIG. 10 is a lateral aberration diagram at infinity according to the second embodiment of the present invention;

FIG. 11 is a lateral aberration diagram at a focusing distance of 3.3 m according to the second embodiment of the present invention;

FIG. 12 is a lateral aberration diagram with vibration reduction of 0.3° at infinity according to the second embodiment of the present invention;

FIG. 13 is a lens configuration diagram at infinity according to a third embodiment of the present invention;

FIG. 14 is a longitudinal aberration diagram at infinity according to the third embodiment of the present invention;

FIG. 15 is a longitudinal aberration diagram at a focusing distance of 3.1 m according to the third embodiment of the present invention;

FIG. 16 is a lateral aberration diagram at infinity according to the third embodiment of the present invention;

FIG. 17 is a lateral aberration diagram at a focusing distance of 3.1 m according to the third embodiment of the present invention;

FIG. 18 is a lateral aberration diagram with vibration reduction of 0.3° at infinity according to the third embodiment of the present invention;

FIG. 19 is a lens configuration diagram at infinity according to a fourth embodiment of the present invention;

FIG. 20 is a longitudinal aberration diagram at infinity according to the fourth embodiment of the present invention;

FIG. 21 is a longitudinal aberration diagram at a focusing distance of 3.2 m according to the fourth embodiment of the present invention;

FIG. 22 is a lateral aberration diagram at infinity according to the fourth embodiment of the present invention;

FIG. 23 is a lateral aberration diagram at a focusing distance of 3.2 m according to the fourth embodiment of the present invention;

FIG. 24 is a lateral aberration diagram with vibration reduction of 0.3° at infinity according to the fourth embodiment of the present invention;

FIG. 25 is a lens configuration diagram at infinity according to a fifth embodiment of the present invention;

FIG. 26 is a longitudinal aberration diagram at infinity according to the fifth embodiment of the present invention;

FIG. 27 is a longitudinal aberration diagram at a focusing distance of 3.3 m according to the fifth embodiment of the present invention;

FIG. 28 is a lateral aberration diagram at infinity according to the fifth embodiment of the present invention;

FIG. 29 is a lateral aberration diagram at a focusing distance of 3.3 m according to the fifth embodiment of the present invention; and

FIG. 30 is a lateral aberration diagram with vibration reduction of 0.3° at infinity according to the fifth embodiment of the present invention.

### DESCRIPTION OF THE EMBODIMENTS

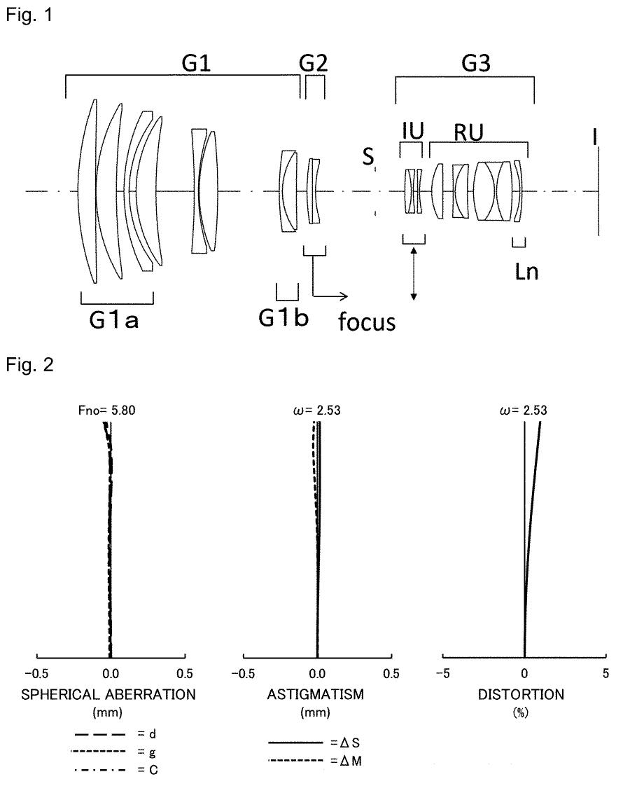

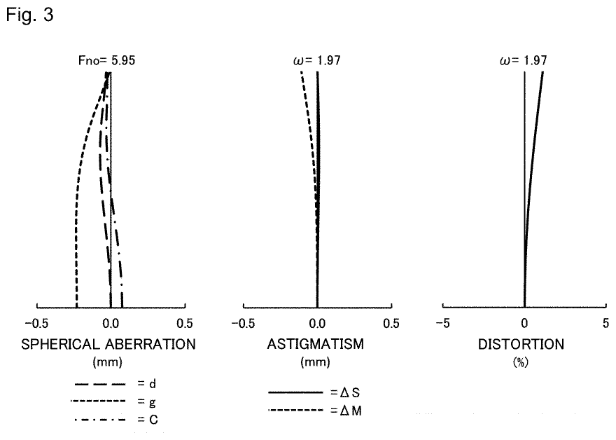

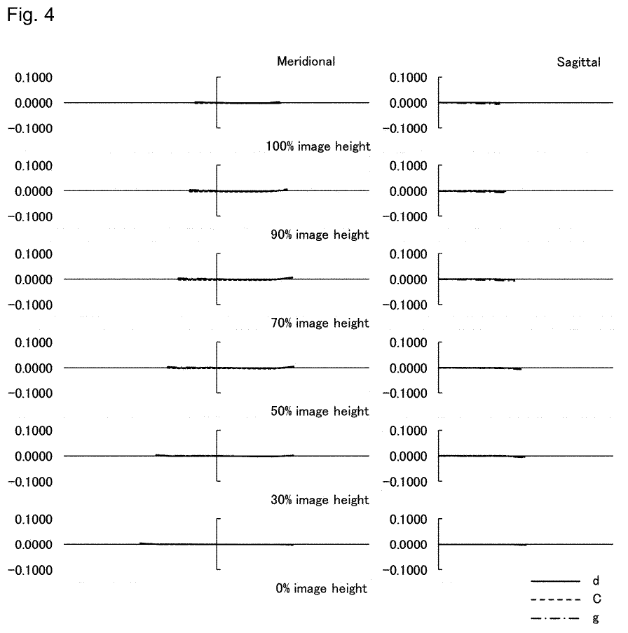

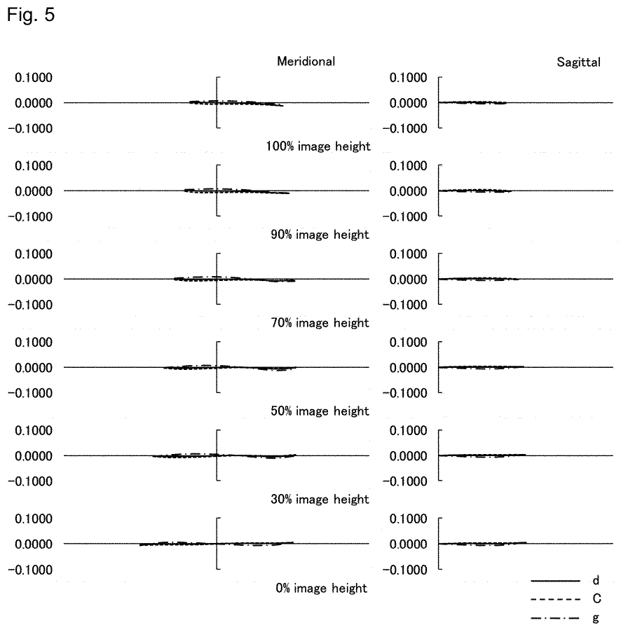

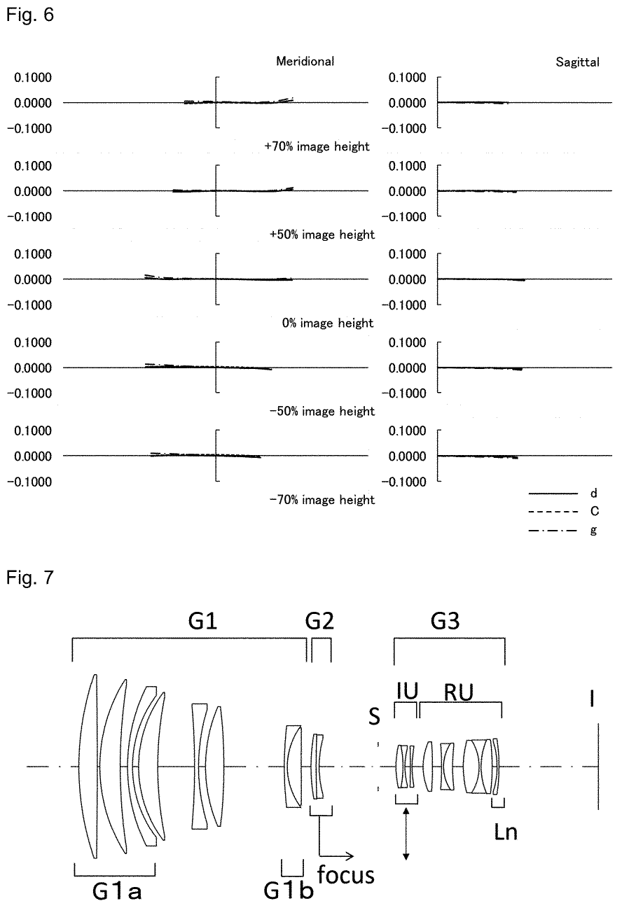

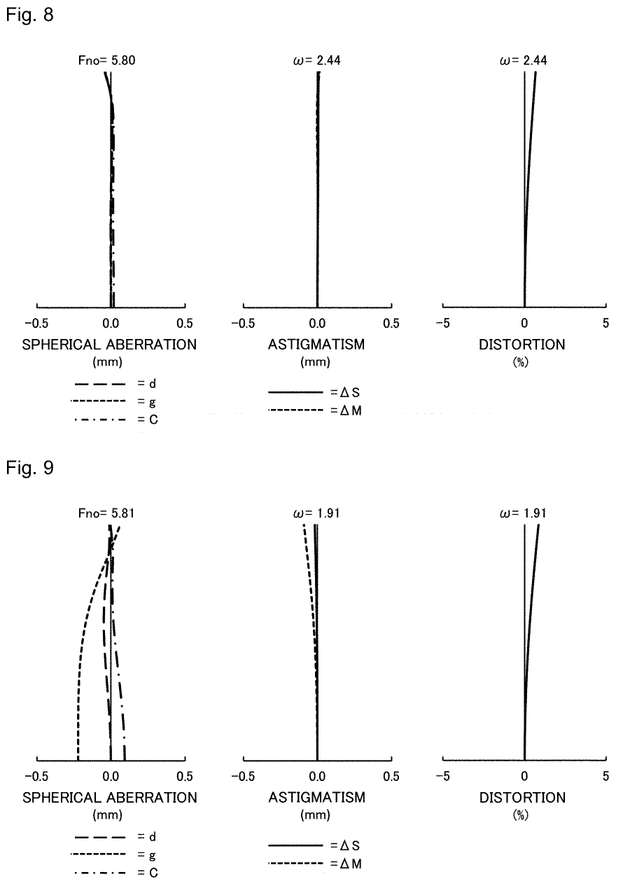

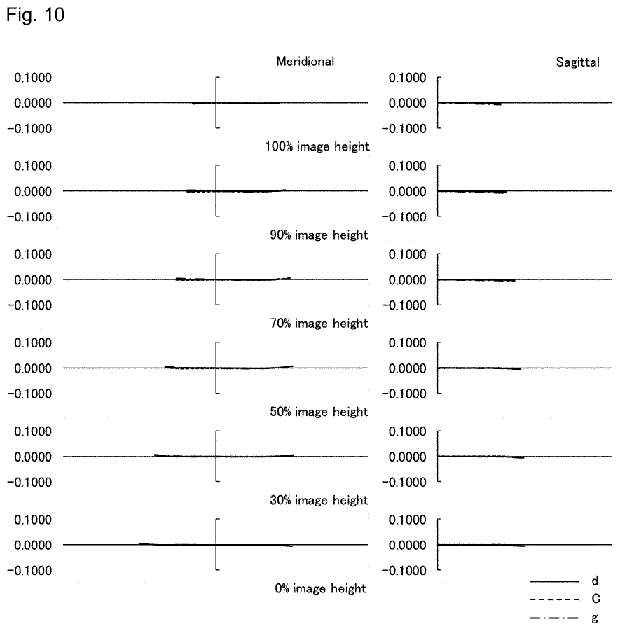

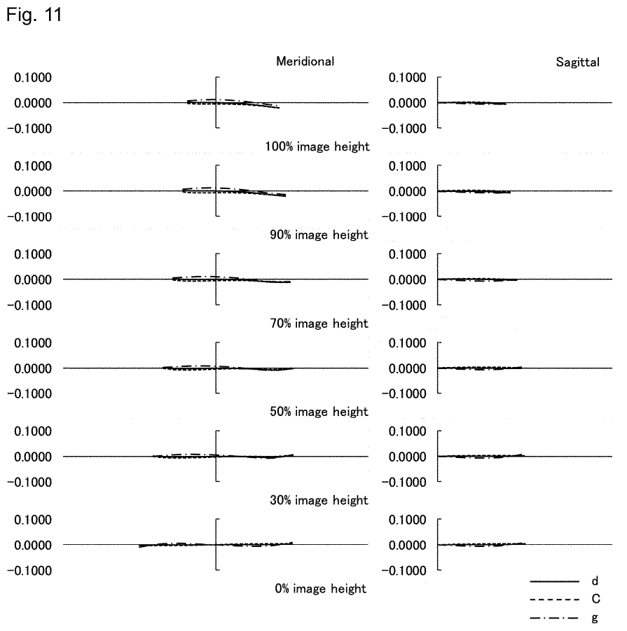

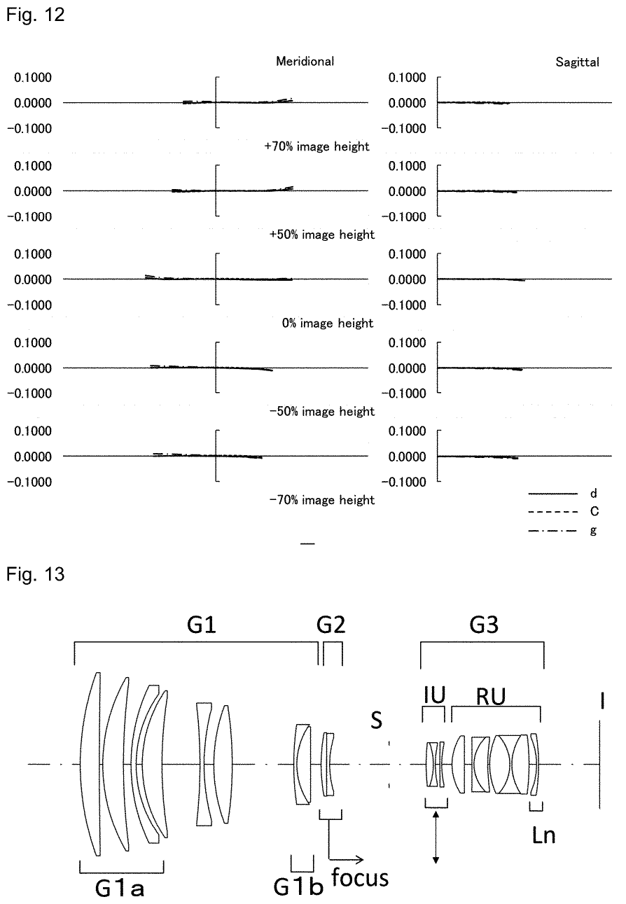

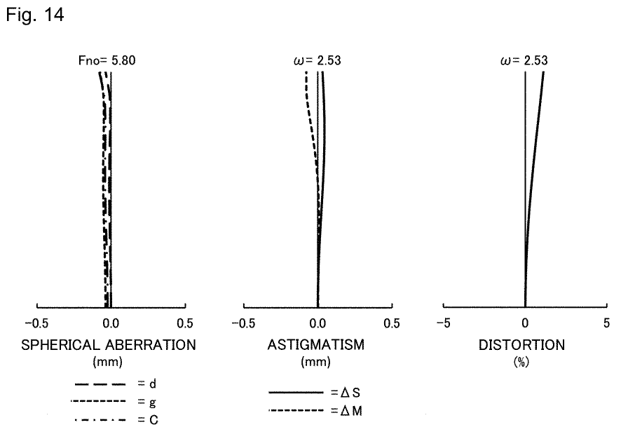

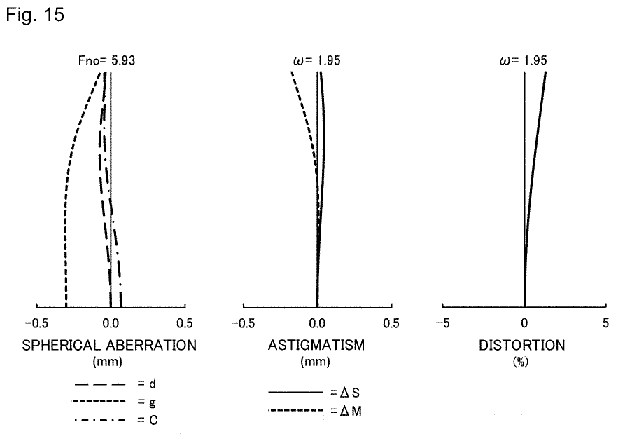

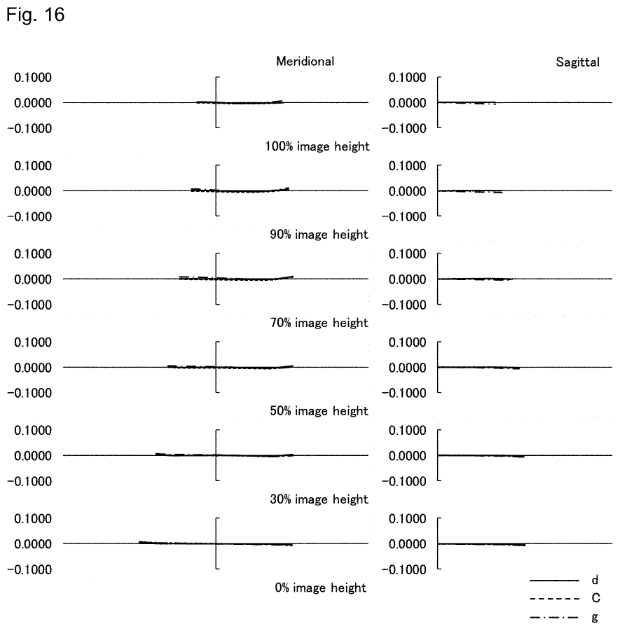

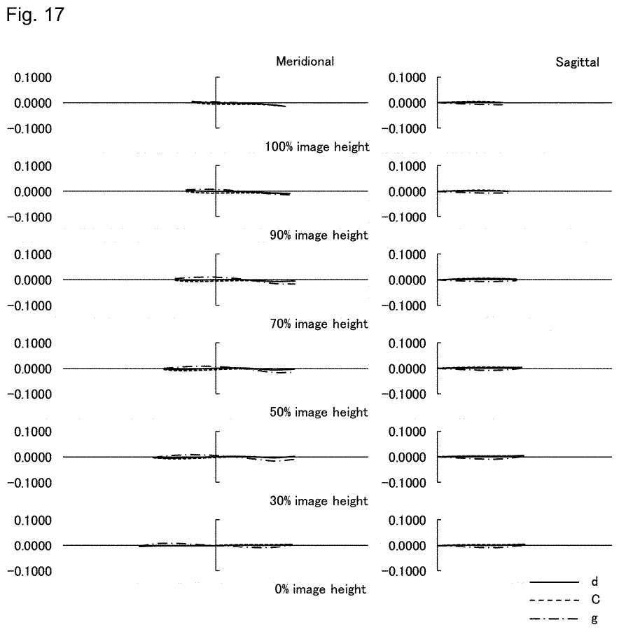

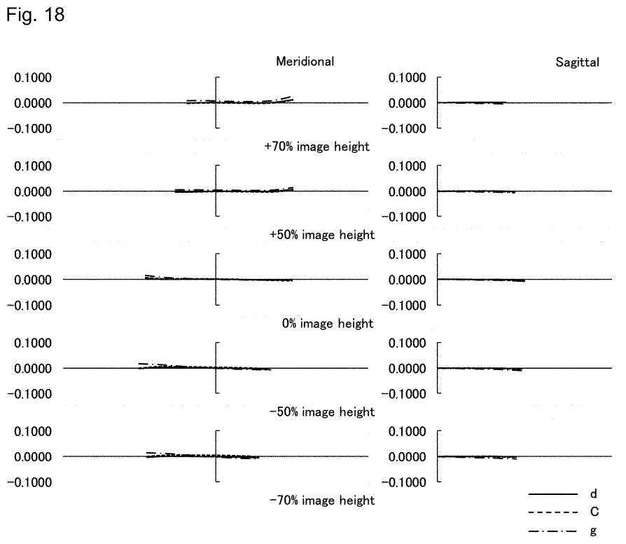

The imaging optical system of the present invention will be described. As is clear from the lens configuration diagrams shown in FIGS. 1, 7, 13, 19, and 25, the imaging optical system of the present invention is characterized by, in order from the object side to the image side, a first group G1 with positive power overall, a second group G2 composed of a lens that moves along the optical axis during focusing, and a third group G3 with power.

By using a configuration composed of such groups, it is possible to reduce the diameters of the focusing units, i.e., the second group G2 and the third group G3 on the basis of the beam converging effect of the first group G1, which has positive power overall. Since the reduction in the diameters of the focusing units, which serve as movable units, facilitates weight reduction, it is also possible to downsize and reduce the weight of the actuator. Since the reduction in the diameters of the second group G2 and the third group G3 also enables the downsizing and weight reduction of the actuator, it becomes possible to achieve a small and lightweight design for a telephoto lens as a whole.

Furthermore, by arranging the first group G1 with positive power on the object side and the second group G2 and the third group G3 with negative power on the image side, it is possible to configure a telephoto-type power arrangement, which produces the effect of reducing the overall length of the imaging optical system. Furthermore, in order to facilitate the provision of a dust and drip-proof mechanism, it is preferable for the first group G1 arranged on the most object side and the lens arranged on the most image side in the imaging optical system to be fixed to an image surface at all times. Furthermore, since it is anticipated that a user may touch the lens arranged on the most image side in the imaging optical system when attaching or detaching a replaceable lens to or from a camera, it is preferable to have a fixed unit arranged at all times with respect to the image surface on the most image side in the imaging optical system.

Furthermore, the first group G1 is composed, in order from the object side to the image side, of a first a group G1a, a plurality of lenses, and a first b group G1b. The first a group G1a has, in order from the most object side, at least two positive lenses and a meniscus-shaped negative lens with its convex surface facing the object side on the most image side. The first b group G1b has, on the most object side, a positive lens or a lens component including a positive lens on the most image side within the first group G1. An air distance D_A11, which is the longest within the first group G1, is provided between the first a group G1a and the first b group G1b. This arrangement enables both weight reduction and aberration correction within the first group G1.

Note that the lens component of the present invention refers to a single lens or a cemented lens. Furthermore, the lens component including a positive lens refers not only to a single positive lens but also to a cemented lens including a positive lens.

Moreover, the imaging optical system of the present invention is characterized by satisfying the following conditional expression:

0.05<D_A11/D_G1<0.44, (1)
where
D_A11 represents the longest air distance within the first group G1, and
D_G1 represents the distance on the optical axis from the object-side lens surface of the lens arranged on the most object side to the image-side lens surface of the lens arranged on the most image side within the first group G1.

The conditional expression (1) specifies the ratio between the longest air distance within the first group G1 and the length along the optical axis of the first group G1 when the imaging optical system is focusing on infinity.

If the longest air distance within the first group G1 exceeds the upper limit of the conditional expression (1), it becomes difficult to arrange both a high-power lens for downsizing and a lens for correcting aberration that occurs within the lens. On the other hand, if the longest air distance within the first group G1 is shorter than the lower limit of the conditional expression (1), lenses with large diameters are arranged closely together, making weight reduction difficult.

It is preferable to limit the upper limit of the conditional expression (1) to 0.40 as this makes the above-described effect more reliable. It is preferable to limit the lower limit of the conditional expression (1) to 0.10 as this makes the above-described effect more reliable.

It is more preferable to limit the upper limit of the conditional expression (1) to 0.35 as this makes the above-described effect more reliable. It is preferable to limit the lower limit of the conditional expression (1) to 0.15 as this makes the above-described effect more reliable.

Moreover, the imaging optical system of the present invention is characterized by satisfying the following conditional expression:

0.10<(D_A11+D_A12)/D_G1<0.70, (2)
where
D_A11 represents the longest air distance within the first group G1, and
D_A12 represents the second-longest air distance between the first a group G1a and the first b group G1b.

The conditional expression (2) specifies the ratio between the sum of the longest air distance within the first group G1 and the second-longest air distance between the first a group G1a and first b group G1b and the length along the optical axis of the first group G1 when the imaging optical system is focusing on infinity.

If the length along the optical axis of the first group G1 is shorter than the upper limit of the conditional expression (2), it becomes further difficult to arrange both a high-power lens for downsizing and a lens for correcting aberration that occurs within the lens. If the sum of the two air distances is shorter than the lower limit of the conditional expression (2), lenses with large diameters are arranged closely together, making weight reduction further difficult.

It is preferable to limit the upper limit of the conditional expression (2) to 0.60 as this makes the above-described effect more reliable. It is preferable to limit the lower limit of the conditional expression (2) to 0.20 as this makes the above-described effect more reliable.

It is more preferable to limit the upper limit of the conditional expression (2) to 0.52 as this makes the above-described effect more reliable. It is preferable to limit the lower limit of the conditional expression (2) to 0.30 as this makes the above-described effect more reliable.

Moreover, the imaging optical system of the present invention is characterized by satisfying the following conditional expression:

0.05<D_G1a/D_G1<0.45 (3)
where
D_G1a represents the length along the optical axis of the first a group G1a, and
D_G1 represents the distance along the optical axis from the object-side lens surface of the lens arranged on the most object side to the image-side lens surface of the lens arranged on the most image side within the first group G1.

The conditional expression (3) specifies the ratio between the length along the optical axis within the first a group G1a and the length along the optical axis of the first group G1 in the imaging optical system.

If the length along the optical axis within the first a group G1a exceeds the upper limit of the conditional expression (3), the volume of lenses with large diameters increases, making weight reduction difficult. If the length along the optical axis of the first group G1 exceeds the lower limit of the conditional expression (3), it becomes difficult to downsize the entire lens system.

It is preferable to limit the upper limit of the conditional expression (3) to 0.40 as this makes the above-described effect more reliable. It is preferable to limit the lower limit of the conditional expression (3) to 0.10 as this makes the above-described effect more reliable.

It is more preferable to limit the upper limit of the conditional expression (3) to 0.35 as this makes the above-described effect more reliable. It is preferable to limit the lower limit of the conditional expression (3) to 0.15 as this makes the above-described effect more reliable.

Moreover, the imaging optical system of the present invention is characterized by satisfying the following conditional expression:

0.15<D_A1all/D_G1<0.75, (4)
where
D_A1all represents the sum of all the air distances within the first group G1, and
D_G1 represents the distance along the optical axis from the object-side lens surface of the lens arranged on the most object side to the image-side lens surface of the lens arranged on the most image side within the first group G1.

The conditional expression (4) specifies the ratio between the sum of all the air distances within the first group G1 and the length along the optical axis of the first group G1 in the imaging optical system.

If the length along the optical axis of the first group G1 is shorter than the upper limit of the conditional expression (4), it becomes further difficult to arrange both a high-power lens for downsizing and a lens for correcting aberration that occurs within the lens. If the sum of all the air distances within the first group G1 is smaller than the lower limit of the conditional expression (4), lenses with large diameters are arranged closely together, making weight reduction further difficult.

It is preferable to limit the upper limit of the conditional expression (4) to 0.70 as this makes the above-described effect more reliable. It is preferable to limit the lower limit of the conditional expression (4) to 0.25 as this makes the above-described effect more reliable.

It is more preferable to limit the upper limit of the conditional expression (4) to 0.65 as this makes the above-described effect more reliable. It is preferable to limit the lower limit of the conditional expression (4) to 0.40 as this makes the above-described effect more reliable.

Moreover, the imaging optical system of the present invention is characterized by satisfying the following conditional expression:

a tan(H_Img/f)<7.00°, (5)
where
H_Img represents the maximum image height, and
f represents the focal length of the imaging optical system when focusing on infinity.

The conditional expression (5) specifies the approximate angle of view of the imaging optical system on the basis of the maximum image height within the imaging optical system and the focal length of the imaging optical system when focusing on infinity.

It is not preferable for the angle of view to exceed the upper limit of the conditional expression (5) as this makes it difficult to arrange lenses suitable for correcting aberration at the peripheral angle of view.

If the value of the conditional expression (5) decreases and the angle of view becomes smaller, the imaging optical system becomes unsuitable for a small and lightweight design, which is the object of the present invention, as the number of lenses in the first group G1 for correcting aberration becomes excessive.

It is preferable to limit the upper limit of the conditional expression (5) to 5.00° as this makes the above-described effect more reliable. It is preferable to limit the lower limit of the conditional expression (5) to 0.40° as this makes the above-described effect more reliable.

It is more preferable to limit the upper limit of the conditional expression (5) to 3.50° as this makes the above-described effect more reliable. It is preferable to limit the lower limit of the conditional expression (5) to 1.00° as this makes the above-described effect more reliable.

Moreover, the imaging optical system of the present invention is characterized by satisfying the following conditional expression:

0.10<LT/f<1.00 (6)
where
LT represents the distance along the optical axis from the surface on the most object side to the image surface when the imaging optical system is focusing on infinity, and
f represents the focal length of the imaging optical system when focusing on infinity.

The conditional expression (6) specifies the ratio between the total lens length and the focal length when the imaging optical system is focusing on infinity.

If the total lens length exceeds the upper limit of the conditional expression (6), it becomes difficult to achieve a small and lightweight design for the telephoto lens. If the total lens length is shorter than the lower limit of the conditional expression (6), it becomes impossible to achieve the large movement amounts of the focusing units. In order to achieve the practical shortest focusing distance, the power of the focusing units needs to be increased. Therefore, the aberration that occurs in the focusing units increases, making it difficult to achieve good performance in a wide focusing distance range.

It is preferable to limit the upper limit of the conditional expression (6) to 0.64 as this makes the above-described effect more reliable. It is preferable to limit the lower limit of the conditional expression (6) to 0.15 as this makes the above-described effect more reliable.

It is more preferable to limit the upper limit of the conditional expression (6) to 0.56 as this makes the above-described effect more reliable. It is preferable to limit the lower limit of the conditional expression (6) to 0.30 as this makes the above-described effect more reliable.

Moreover, the imaging optical system of the present invention is characterized in that the first b group G1b is composed of a negative lens and a positive lens, or a positive lens and a negative lens.

The first b group G1b preferably uses a single negative lens and a single positive lens for chromatic aberration correction and weight reduction. Furthermore, a cemented lens is preferably used for simplification of a lens configuration.

Moreover, the imaging optical system of the present invention is characterized by satisfying the following conditional expression:

−60.00<Φ_G2G3/Φ<−3.00, (7)
where
Φ represents the power of the imaging optical system when focusing on infinity, and
Φ_G2G3 represents the combined power of the second group G2 and the third group G3 when the imaging optical system is focusing on infinity.

The conditional expression (7) specifies the ratio between the combined power of the second group G2 and the third group G3 and the power of the entire system when the imaging optical system is focusing on infinity.

If the negative combined power of the second group G2 and the third group G3 is smaller than the upper limit of the conditional expression (7), the telephoto effect weakens, making it difficult to downsize the imaging optical system. If the negative combined power of the second group G2 and the third group G3 exceeds the lower limit of the conditional expression (7), the function of increasing aberration becomes significant, making it difficult to achieve good performance.

It is preferable to limit the upper limit of the conditional expression (7) to −5.00 as this makes the above-described effect more reliable. It is preferable to limit the lower limit of the conditional expression (7) to −50.00 as this makes the above-described effect more reliable.

It is more preferable to limit the upper limit of the conditional expression (7) to −8.30 as this makes the above-described effect more reliable. It is preferable to limit the lower limit of the conditional expression (7) to −25.00 as this makes the above-described effect more reliable.

1.00<D_EXP/H_Img<11.00, (8)
where
D_EXP represents the distance from an exit pupil to the image surface when the imaging optical system is focusing on infinity, and
H_Img represents the maximum image height.

The conditional expression (8) specifies the ratio between the distance from the exit pupil to the image surface and the maximum image height when the imaging optical system is focusing on infinity.

If the exit pupil moves farther from the image surface toward the object side beyond the upper limit of the conditional expression (8), the ray height near the image surface increases. However, since there is a part near the image surface for attaching to the camera and the ray is vignetted, it becomes difficult to ensure sufficient peripheral illumination. If the exit pupil moves closer to the image surface beyond the lower limit of the conditional expression (8), the exit angle of the principal ray of the lens arranged on the most image side increases. When an image sensor used in a digital camera or the like is used, the image sensor generally has the characteristic of reduced sensitivity to light with a large angle of incidence. Therefore, if the angle of incidence of the ray is large, it becomes difficult to ensure sufficient peripheral illumination.

It is preferable to limit the upper limit of the conditional expression (8) to 8.00 as this makes the above-described effect more reliable. It is preferable to limit the lower limit of the conditional expression (8) to 2.00 as this makes the above-described effect more reliable.

It is more preferable to limit the upper limit of the conditional expression (8) to 4.30 as this makes the above-described effect more reliable. It is preferable to limit the lower limit of the conditional expression (8) to 2.70 as this makes the above-described effect more reliable.

Moreover, the imaging optical system of the present invention is characterized by satisfying the following conditional expression:

−35.00<Φ_G3/Φ<−1.00, (9)
where
Φ_G3 represents the power of the third group G3, and
Φ represents the power of the imaging optical system when focusing on infinity.

The conditional expression (9) specifies the ratio between the power of the third group G3 and the power of the entire system.

If the negative power of the third group G3 is smaller than the upper limit of the conditional expression (9), the negative power of the second group G2 needs to be increased to maintain the telephoto-type power arrangement while maintaining the focal length of the entire system. If the negative power of the second group G2, which is a focusing unit, becomes too large, the fluctuation of astigmatism increases during focusing, making it difficult to achieve good performance in a wide focusing distance range. If the negative power of the third group G3 exceeds the lower limit of the conditional expression (9), it becomes difficult to ensure sufficient back focus. Furthermore, the function of increasing aberration becomes significant, making it difficult to achieve good performance.

It is preferable to limit the upper limit of the conditional expression (9) to −1.50 as this makes the above-described effect more reliable. It is preferable to limit the lower limit of the conditional expression (9) to −26.00 as this makes the above-described effect more reliable.

It is more preferable to limit the upper limit of the conditional expression (9) to −4.00 as this makes the above-described effect more reliable. It is preferable to limit the lower limit of the conditional expression (9) to −11.00 as this makes the above-described effect more reliable.

Moreover, the imaging optical system of the present invention is characterized in that the third group G3 has an image blur correction unit IU and a rear unit RU provided on the image side of the image blur correction unit IU. The image blur correction unit IU and the rear unit RU have different power signs, and the image blur correction unit IU has at least one positive lens and at least one negative lens. The imaging optical system is characterized by satisfying the following conditional expression:

3.00<|Φ_OS/Φ|<35.00, (10)
where
Φ_OS represents the power of the image blur correction unit IU, and
Φ represents the power of the imaging optical system when focusing on infinity.

By arranging the rear unit RU with a power sign different from that of the image blur correction unit IU, it is possible to increase the power of the image blur correction unit IU while maintaining the power of the third group G3, thereby increasing the image blur correction amount (hereinafter referred to as the variation reduction coefficient) relative to the movement amount of the image blur correction unit IU. Since increasing the variation reduction coefficient reduces the movement amount of the image blur correction unit IU, it becomes possible to reduce the size of the actuator, which is advantageous for downsizing and weight reduction of the telephoto lens.

Furthermore, since the image blur correction unit IU has at least one positive lens and at least one negative lens, it is possible to correct chromatic aberration within the image blur correction unit IU, thereby achieving good performance during image blur correction.

The conditional expression (10) specifies the ratio between the power of the image blur correction unit IU and the power of the imaging optical system.

If the power of the image blur correction unit IU is smaller than the lower limit of the conditional expression (10), the vibration reduction coefficient decreases. Therefore, it becomes necessary to increase the driving amount of the image blur correction unit IU, making it difficult to downsize the actuator and, by extension, the telephoto lens. If the power of the image blur correction unit IU exceeds the upper limit of the conditional expression (10), the vibration reduction coefficient can be increased. However, aberration that occurs in the image blur correction unit IU increases, and the fluctuation of comatic aberration or astigmatism increases when the image blur correction unit IU is driven in a direction perpendicular to the optical axis. Therefore, it becomes difficult to achieve good performance during image blur correction.

It is preferable to limit the upper limit of the conditional expression (10) to 26.00 as this makes the above-described effect more reliable. It is preferable to limit the lower limit of the conditional expression (10) to 5.00 as this makes the above-described effect more reliable.

It is more preferable to limit the upper limit of the conditional expression (10) to 22.00 as this makes the above-described effect more reliable. It is preferable to limit the lower limit of the conditional expression (10) to 7.00 as this makes the above-described effect more reliable.

Moreover, the imaging optical system of the present invention is characterized by satisfying the following conditional expression:

−20.00<Φ_G2/Φ<−0.13, (11)
where
Φ_G2 represents the power of the second group G2, and
Φ represents the power of the imaging optical system when focusing on infinity.

The conditional expression (11) specifies the preferred range for the ratio between the power of the second group G2 and the power of the imaging optical system.

If the negative power of the second group G2 is smaller than the upper limit of the conditional expression (11), the third group G3 takes on the role of the negative power positioned on the image side in the telephoto type, resulting in an increase in the negative power of the third group G3. The function of increasing aberration becomes significant in the third group G3, making it difficult to achieve good performance. If the negative power of the second group G2 exceeds the lower limit of the conditional expression (11), aberration, particularly astigmatism, is more likely to occur in the second group G2, which is a focusing unit, making it difficult to achieve good performance in a wide focusing distance range.

It is preferable to limit the upper limit of the conditional expression (11) to −0.20 as this makes the above-described effect more reliable. It is preferable to limit the lower limit of the conditional expression (11) to −12.00 as this makes the above-described effect more reliable.

It is more preferable to limit the lower limit of the conditional expression (11) to −6.00 as this makes the above-described effect more reliable.

Moreover, the imaging optical system of the present invention is characterized by including a negative lens that satisfies the following conditional expressions on the image side of the aperture diaphragm:

10.00<ν_d<30.00 (12)

0.020<P_gF+0.0018*ν_d−0.6483<0.080 (13)
where
ν_d represents an Abbe number for the d-line of the negative lens, and
P_gF represents a partial dispersion ratio for the g-line and F-line of the negative lens.

The partial dispersion ratio P_gF=(ng−nF)/(nF−nC) is specified.
ng represents a refractive index for the g-line (wavelength λ=435.84 nm).
nF represents a refractive index for the F-line (wavelength λ=486.13 nm).
nC represents a refractive index for a C-line (wavelength λ=656.27 nm).

By having the negative lens that satisfies the conditional expressions (12) and (13) on the image side of the aperture diaphragm S, it is possible to achieve good chromatic aberration correction.

The conditional expression (12) specifies the preferred range of the Abbe number for the d-line of the negative lens.

If the Abbe number for the d-line exceeds the upper limit of the conditional expression (12), the function of canceling chromatic aberration weakens, making it difficult to correct the chromatic aberration throughout the entire lens system.

Furthermore, it becomes difficult to select a material that satisfies the conditional expression (13). If the Abbe number for the d-line is smaller than the lower limit of the conditional expression (12), the function of increasing chromatic aberration becomes significant, making it difficult to correct the chromatic aberration throughout the entire lens system.

It is preferable to limit the upper limit of the conditional expression (12) to 24.00 as this makes the above-described effect more reliable. It is preferable to limit the lower limit of the conditional expression (12) to 15.00 as this makes the above-described effect more reliable.

It is more preferable to limit the upper limit of the conditional expression (12) to 21.00 as this makes the above-described effect more reliable. It is preferable to limit the lower limit of the conditional expression (12) to 16.00 as this makes the above-described effect more reliable.

The conditional expression (13) specifies the preferred range of the partial dispersion ratio for the g-line and the F-line of the negative lens.

If the partial dispersion ratio for the g-line and the F-line exceeds the upper limit of the conditional expression (13), particularly the chromatic aberration of the g-line increases in the positive direction, making it difficult to correct the chromatic aberration throughout the entire lens system. If the partial dispersion ratio for the g-line and the F-line is smaller than the lower limit of the conditional expression (13), particularly the chromatic aberration of the g-line increases in the negative direction, making it difficult to correct the chromatic aberration throughout the entire lens system.

It is preferable to limit the upper limit of the conditional expression (13) to 0.048 as this makes the above-described effect more reliable. It is preferable to limit the lower limit of the conditional expression (13) to 0.024 as this makes the above-described effect more reliable.

It is more preferable to limit the upper limit of the conditional expression (13) to 0.041 as this makes the above-described effect more reliable. It is preferable to limit the lower limit of the conditional expression (13) to 0.027 as this makes the above-described effect more reliable.

Moreover, the imaging optical system of the present invention is characterized in that the object-side surfaces and the image-side surfaces of all the lenses are formed from a spherical surface or a flat surface. Spherical lenses can be processed uniformly even if they rotate about the spherical center during processing. Therefore, it is easier to manufacture spherical lenses compared to non-spherical lenses. Since the lenses that configure the imaging optical system of a telephoto lens tend to have a large diameter, it is preferable to obtain lenses with excellent processing accuracy at a low manufacturing cost.

Next, the lens configuration in embodiments related to the imaging optical system of the present invention will be described. Note that, in the following description, the lens configuration will be presented in order from the object side to the image side.

Specific numerical data for each embodiment of the imaging optical system of the present invention is provided.

In [Surface Data], the surface number represents the number of a lens surface or an aperture diaphragm counted from the object side, r represents the curvature radius of each surface, d represents the distance between surfaces, nd represents the refractive index for the d-line (wavelength of 587.56 nm), vd represents the Abbe number for the d-line, and P_gF represents the partial dispersion ratio for the g-line and the F-line.

BF represents the back focus.

The label “diaphragm” attached to the surface number indicates that the aperture diaphragm S is located at that position. The curvature radius for the flat surface or the aperture diaphragm S is recorded as ∞ (infinity).

In [Various Data], the values of the focal length and the like at focusing distances of infinity (INF), 20 m, and 3.2 m are indicated.

In [Variable Distance Data], the values of the variable distances and the BF at focusing distances of INF, 20 m, and 3.2 m are indicated.

In [Lens Group Data], the surface numbers on the most object side configuring the lens groups, as well as the combined focal lengths of the entire groups, are indicated.

Note that all the specification values listed below use millimeter (mm) as the units for focal length f, curvature radius r, the distance d between lens surfaces, and other lengths, unless otherwise specifically noted. However, in the optical system, equivalent optical performance is achieved in both proportional magnification and proportional reduction, and therefore, these values are not limited to this unit.

Furthermore, in the lens configuration diagram of each embodiment, an arrow represents the path of the lens group during zooming from the wide-angle end to the telephoto end, “I” represents the image surface, and the one-dot chain line passing through the center represents the optical axis.

In the aberration diagram corresponding to each embodiment, d, g, and C represent the d-line, the g-line, and the C-line, respectively, and ΔS and ΔM represent the sagittal image surface and the meridional image surface, respectively.

### First Embodiment

FIG. 1 is the lens configuration diagram of the imaging optical system according to a first embodiment of the present invention. The first group G1 is composed of: a meniscus-shaped positive lens L1 with its convex surface facing the object side; a meniscus-shaped positive lens L2 with its convex surface facing the object side; a meniscus-shaped negative lens L3 with its convex surface facing the object side; a meniscus-shaped positive lens L4 with its convex surface facing the object side; a double concave negative lens L5; a double convex positive lens L6; and a cemented lens including a meniscus-shaped negative lens L7 with its convex surface facing the object side and a meniscus-shaped positive lens L8 with its convex surface facing the object side. The first group G1 has positive power overall. Furthermore, the first group G1 is fixed to the image surface at all times. Here, the first a group G1a is composed of the lenses L1, L2, and L3, and the first b group G1b is composed of the lenses L7 and L8.

The second group G2 is composed of a cemented lens including a meniscus-shaped positive lens L9 with its convex surface facing the object side and a meniscus-shaped negative lens L10 with its convex surface facing the object side. The second group G2 has negative power overall. Furthermore, the second group G2 moves along the optical axis from the object side toward the image side during focusing from an infinite distance object to a close distance object.

The third group G3 is composed of the image blur correction unit IU and the rear unit RU and has negative power overall. Furthermore, the third group G3 is fixed to the image surface during focusing.

The image blur correction unit IU is composed of a cemented lens including a double convex positive lens L11 and a double concave negative lens L12, as well as a double concave negative lens L13. The image blur correction unit IU has negative power overall. Furthermore, the image blur correction unit IU moves in a direction approximately perpendicular to the optical axis to reduce image blur caused by shake in the imaging optical system.

The rear unit RU is composed of: a double convex positive lens L14; a cemented lens including a double concave negative lens L15 and a meniscus-shaped positive lens L16 with its convex surface facing the object side; a three-element cemented lens including a double convex positive lens L17, a double concave negative lens L18, and a double convex positive lens L19; and a meniscus-shaped negative lens L20 with its concave surface facing the object side. The rear unit RU has negative power overall. Furthermore, the rear unit RU is fixed to the image surface at all times.

The aperture diaphragm S is arranged between the second group G2 and the third group G3. The lens component Ln, which is arranged on the most image side within the imaging optical system, is the negative lens L20.

Next, the specification values for the imaging optical system according to the first embodiment are provided below.

### Numerical Example 1

Unit: mm
[Surface Data]

| Surface Number | r | d | nd | vd | P_gF |
|---|---|---|---|---|---|
| Object Surface | ∞ | (d0) | | | |
| 1 | 128.6213 | 8.5472 | 1.49700 | 81.61 | 0.5389 |
| 2 | 1855.0184 | 0.2257 | | | |
| 3 | 82.1712 | 9.8467 | 1.43700 | 95.10 | 0.5336 |
| 1 | 291.1918 | 3.7000 | | | |
| 5 | 86.2308 | 2.5000 | 1.77250 | 49.63 | 0.5504 |
| 6 | 57.9504 | 3.3543 | | | |
| 7 | 61.4411 | 9.6400 | 1.43700 | 95.10 | 0.5336 |
| 8 | 197.3978 | 18.5622 | | | |
| 9 | −333.8043 | 2.0000 | 1.77250 | 49.63 | 0.5504 |
| 10 | 93.3984 | 0.3617 | | | |
| 11 | 73.6505 | 9.0058 | 1.43700 | 95.10 | 0.5336 |
| 12 | −256.0975 | 29.8177 | | | |
| 13 | 126.7983 | 1.5000 | 1.77250 | 49.63 | 0.5504 |
| 14 | 32.4202 | 6.7928 | 1.56732 | 42.84 | 0.5744 |
| 15 | 614.6770 | (d15) | | | |
| 16 | 91.7650 | 2.6326 | 1.67270 | 32.17 | 0.5963 |
| 17 | 5455.7778 | 1.5000 | 1.77250 | 49.63 | 0.5504 |
| 18 | 49.7976 | (d18) | | | |
| 19 (Diaphragm) | ∞ | 14.3265 | | | |
| 20 | 115.6881 | 3.1058 | 1.67270 | 32.17 | 0.5963 |
| 21 | −37.9788 | 1.0000 | 1.59282 | 68.62 | 0.5440 |
| 22 | 70.0614 | 2.1219 | | | |
| 23 | −243.6318 | 0.9000 | 1.88300 | 40.81 | 0.5656 |
| 24 | 47.2089 | 5.8618 | | | |
| 25 | 28.0943 | 5.4009 | 1.68960 | 31.14 | 0.6031 |
| 26 | −1449.5194 | 5.0141 | | | |
| 27 | −357.0678 | 1.0000 | 1.94594 | 17.98 | 0.6546 |
| 28 | 21.1709 | 5.9068 | 1.69895 | 30.05 | 0.6028 |
| 29 | 149.0456 | 2.9324 | | | |
| 30 | 41.7292 | 10.1981 | 1.75520 | 27.53 | 0.6098 |
| 31 | −22.5524 | 1.0000 | 1.88300 | 40.81 | 0.5656 |
| 32 | 31.9918 | 7.5209 | 1.77047 | 29.74 | 0.5951 |
| 33 | −92.9755 | 3.7907 | | | |
| 34 | −34.1613 | 1.0000 | 1.90043 | 37.37 | 0.5767 |
| 35 | −86.9114 | (BF) | | | |
| Image Surface | ∞ | | | | |

[Various Data]

| | INF | 20 m | 3.2 m |
|---|---|---|---|
| Focal Length | 485.00 | 429.90 | 258.32 |
| F-Number | 5.80 | 5.80 | 5.95 |
| Full Angle of | 5.06 | 4.88 | 3.95 |
| View 2ω | | | |
| Image Height Y | 21.63 | 21.63 | 21.63 |
| Total Lens Length | 252.34 | 252.34 | 252.34 |

[Variable Distance Data]

| | INF | 20 m | 3.2 m |
|---|---|---|---|
| d0 | ∞ | 19410.1882 | 2898.0257 |
| d15 | 5.1467 | 7.4232 | 21.9757 |
| d18 | 28.9503 | 26.6738 | 12.1213 |
| BF | 37.1732 | 37.1732 | 37.1732 |

[Lens Group Data]

| Group | Start Surface | Focal Length |
|---|---|---|
| G1 | 1 | 171.54 |
| G2 | 16 | −126.77 |
| G3 | 20 | −78.05 |
| IU | 20 | −44.51 |
| RU | 25 | 65.16 |
| Ln | 34 | −63.07 |
| Second Embodiment | | |

FIG. 7 is the lens configuration diagram of the imaging optical system according to a second embodiment of the present invention. The first group G1 is composed of: a double convex positive lens L1; a meniscus-shaped positive lens L2 with its convex surface facing the object side; a meniscus-shaped negative lens L3 with its convex surface facing the object side; a meniscus-shaped positive lens L4 with its convex surface facing the object side; a double concave negative lens L5; a double convex positive lens L6; and a cemented lens including a meniscus-shaped negative lens L7 with its convex surface facing the object side and a meniscus-shaped positive lens L8 with its convex surface facing the object side. The first group G1 has positive power overall. Furthermore, the first group G1 is fixed to the image surface at all times. Here, the first a group G1a is composed of the lenses L1, L2, and L3, and the first b group G1b is composed of the lenses L7 and L8.

The second group G2 is composed of a cemented lens including a meniscus-shaped positive lens L9 with its convex surface facing the object side and a meniscus-shaped negative lens L10 with its convex surface facing the object side. The second group G2 has negative power overall. Furthermore, the second group G2 moves along the optical axis from the object side toward the image side during focusing from an infinite distance object to a close distance object.

The third group G3 is composed of the image blur correction unit IU and the rear unit RU and has negative power overall. Furthermore, the third group G3 is fixed to the image surface during focusing.

The image blur correction unit IU is composed of a cemented lens including a double convex positive lens L11 and a double concave negative lens L12, as well as a double concave negative lens L13. The image blur correction unit IU has negative power overall. Furthermore, the image blur correction unit IU moves in a direction approximately perpendicular to the optical axis to reduce image blur caused by shake in the imaging optical system.

The rear unit RU is composed of: a double convex positive lens L14; a cemented lens including a double concave negative lens L15 and a meniscus-shaped positive lens L16 with its convex surface facing the object side; a three-element cemented lens including a double convex positive lens L17, a double concave negative lens L18, and a double convex positive lens L19; and a meniscus-shaped negative lens L20 with its concave surface facing the object side. The rear unit RU has negative power overall. Furthermore, the rear unit RU is fixed to the image surface at all times.

The aperture diaphragm S is arranged between the second group G2 and the third group G3. The lens component Ln, which is arranged on the most image side within the imaging optical system, is the negative lens L20.

Next, the specification values for the imaging optical system according to the second embodiment are provided below.

### Numerical Example 2

Unit: mm
[Surface Data]

| Surface Number | r | d | nd | vd | P_gF |
|---|---|---|---|---|---|
| Object Surface | ∞ | (d0) | | | |
| 1 | 140.7884 | 9.2799 | 1.49700 | 81.61 | 0.5389 |
| 2 | −2983.6838 | 1.3052 | | | |
| 3 | 80.6730 | 10.2729 | 1.43700 | 95.10 | 0.5336 |
| 4 | 267.2084 | 3.7000 | | | |
| 5 | 88.2176 | 2.5000 | 1.77250 | 49.63 | 0.5504 |
| 6 | 58.6143 | 3.0731 | | | |
| 7 | 61.1979 | 9.6400 | 1.43700 | 95.10 | 0.5336 |
| 8 | 174.3498 | 18.5785 | | | |
| 9 | −346.0581 | 2.0000 | 1.77250 | 49.63 | 0.5504 |
| 10 | 96.0936 | 3.5160 | | | |
| 11 | 75.0504 | 9.2576 | 1.43700 | 95.10 | 0.5336 |
| 12 | −256.0553 | 30.4691 | | | |
| 13 | 179.2783 | 1.5000 | 1.77250 | 49.63 | 0.5504 |
| 14 | 33.6244 | 7.0233 | 1.56732 | 42.84 | 0.5744 |
| 15 | 1876.2500 | (d15) | | | |
| 16 | 91.4634 | 2.6101 | 1.67270 | 32.17 | 0.5963 |
| 17 | 430.5662 | 1.5000 | 1.77250 | 49.63 | 0.5504 |
| 18 | 52.4328 | (d18) | | | |
| 19 (Diaphragm) | ∞ | 8.9386 | | | |
| 20 | 47.2400 | 3.5406 | 1.64769 | 33.84 | 0.5924 |
| 21 | −53.3700 | 1.0000 | 1.59410 | 60.47 | 0.5552 |
| 22 | 36.8596 | 2.7076 | | | |
| 23 | −470.0733 | 0.9000 | 1.88300 | 40.81 | 0.5656 |
| 24 | 52.0060 | 5.5310 | | | |
| 25 | 30.1323 | 4.7326 | 1.69895 | 30.05 | 0.6028 |
| 26 | −167.2045 | 4.5845 | | | |
| 27 | −137.6655 | 1.0000 | 1.92286 | 20.88 | 0.6390 |
| 28 | 20.9954 | 4.5531 | 1.72047 | 34.71 | 0.5834 |
| 29 | 95.3035 | 5.3990 | | | |
| 30 | 49.7673 | 7.9623 | 1.77047 | 29.74 | 0.5951 |
| 31 | −24.7722 | 1.0000 | 1.88100 | 40.14 | 0.5700 |
| 32 | 33.7336 | 5.5745 | 1.77047 | 29.74 | 0.5951 |
| 33 | −101.9666 | 2.4752 | | | |
| 34 | −41.3845 | 1.0000 | 1.91082 | 35.25 | 0.5822 |
| 35 | −88.8866 | (BF) | | | |
| Image Surface | ∞ | | | | |

[Various Data]

| | INF | 20 m | 3.3 m |
|---|---|---|---|
| Focal Length | 504.99 | 455.35 | 287.93 |
| F-Number | 5.80 | 5.81 | 5.81 |
| Full Angle of | 4.87 | 4.69 | 3.81 |
| View 2ω | | | |
| Image Height Y | 21.63 | 21.63 | 21.63 |
| Total Lens Length | 261.95 | 261.95 | 261.95 |

[Variable Distance Data]

| | INF | 20 m | 3.3 m |
|---|---|---|---|
| d0 | ∞ | 20213.4581 | 3014.6257 |
| d15 | 4.9136 | 7.6311 | 25.3377 |
| d18 | 29.7949 | 27.0774 | 9.3709 |
| BF | 50.1169 | 50.1169 | 50.1170 |

[Lens Group Data]

| Group | Start Surface | Focal Length |
|---|---|---|
| G1 | 1 | 187.32 |
| G2 | 16 | −145.23 |
| G3 | 20 | −102.31 |
| IU | 20 | −52.63 |
| RU | 25 | 79.76 |
| Ln | 34 | −85.88 |
| Third Embodiment | | |

FIG. 13 is the lens configuration diagram of the imaging optical system according to a third embodiment of the present invention. The first group G1 is composed of: a meniscus-shaped positive lens L1 with its convex surface facing the object side; a meniscus-shaped positive lens L2 with its convex surface facing the object side; a meniscus-shaped negative lens L3 with its convex surface facing the object side; a meniscus-shaped positive lens L4 with its convex surface facing the object side; a double concave negative lens L5; a double convex positive lens L6; and a cemented lens including a meniscus-shaped negative lens L7 with its convex surface facing the object side and a meniscus-shaped positive lens L8 with its convex surface facing the object side. The first group G1 has positive power overall. Furthermore, the first group G1 is fixed to the image surface at all times. Here, the first a group G1a is composed of the lenses L1, L2, and L3, and the first b group G1b is composed of the lenses L7 and L8.

The second group G2 is composed of a cemented lens including a meniscus-shaped positive lens L9 with its convex surface facing the object side and a meniscus-shaped negative lens L10 with its convex surface facing the object side. The second group G2 has negative power overall. Furthermore, the second group G2 moves along the optical axis from the object side toward the image side during focusing from an infinite distance object to a close distance object.

The third group G3 is composed of the image blur correction unit IU and the rear unit RU and has negative power overall. Furthermore, the third group G3 is fixed to the image surface during focusing.

The image blur correction unit IU is composed of a cemented lens including a double convex positive lens L11 and a double concave negative lens L12, as well as a meniscus-shaped negative lens L13 with its convex surface facing the object side. The image blur correction unit IU has negative power overall. Furthermore, the image blur correction unit IU moves in a direction approximately perpendicular to the optical axis to reduce image blur caused by shake in the imaging optical system.

The rear unit RU is composed of: a double convex positive lens L14; a cemented lens including a double concave negative lens L15 and a meniscus-shaped positive lens L16 with its convex surface facing the object side; a three-element cemented lens including a double convex positive lens L17, a double concave negative lens L18, and a double convex positive lens L19; and a meniscus-shaped negative lens L20 with its concave surface facing the object side. The rear unit RU has negative power overall. Furthermore, the rear unit RU is fixed to the image surface at all times.

The aperture diaphragm S is arranged between the second group G2 and the third group G3. The lens component Ln, which is arranged on the most image side within the imaging optical system, is the negative lens L20.

Next, the specification values for the imaging optical system according to the third embodiment are provided below.

### Numerical Example 3

Unit: mm
[Surface Data]

| Surface Number | r | d | nd | vd | P_gF |
|---|---|---|---|---|---|
| Surface Number | ∞ | (d0) | | | |
| 1 | 129.1671 | 9.3042 | 1.49700 | 81.61 | 0.5389 |
| 2 | 1997.2381 | 1.6817 | | | |
| 3 | 83.2780 | 10.1121 | 1.43700 | 95.10 | 0.5336 |
| 4 | 308.2174 | 3.7000 | | | |
| 5 | 87.5533 | 2.5000 | 1.77250 | 49.63 | 0.5504 |
| 6 | 58.3974 | 2.9835 | | | |
| 7 | 62.7900 | 9.6400 | 1.43700 | 95.10 | 0.5336 |
| 8 | 211.2563 | 18.5318 | | | |
| 9 | 251.1669 | 2.0000 | 1.77250 | 49.63 | 0.5504 |
| 10 | 102.3545 | 4.7635 | | | |
| 11 | 80.9017 | 8.9888 | 1.43700 | 95.10 | 0.5336 |
| 12 | −185.6506 | 30.0422 | | | |
| 13 | 135.3400 | 1.5000 | 1.77250 | 49.63 | 0.5504 |
| 14 | 33.5732 | 6.7076 | 1.56732 | 42.84 | 0.5744 |
| 15 | 8516.1691 | (d15) | | | |
| 16 | 85.4947 | 2.6556 | 1.68960 | 31.14 | 0.6031 |
| 17 | 2193.1449 | 1.5000 | 1.77250 | 49.63 | 0.5504 |
| 18 | 45.4644 | (d18) | | | |
| 19 (Diaphragm) | ∞ | 18.0876 | | | |
| 20 | 104.0250 | 3.4744 | 1.62004 | 36.26 | 0.5922 |
| 21 | −31.6896 | 1.0000 | 1.61997 | 63.88 | 0.5426 |
| 22 | 47.0550 | 2.2173 | | | |
| 23 | 964.2787 | 0.9000 | 1.88300 | 40.81 | 0.5656 |
| 24 | 46.1161 | 5.0266 | | | |
| 25 | 25.6649 | 6.0771 | 1.67270 | 32.17 | 0.5963 |
| 26 | −1312.8296 | 3.6458 | | | |
| 27 | −2120.5231 | 1.0000 | 1.94594 | 17.98 | 0.6546 |
| 28 | 18.2224 | 6.7476 | 1.69895 | 30.05 | 0.6028 |
| 29 | 88.4439 | 0.9216 | | | |
| 30 | 34.2077 | 9.8217 | 1.75520 | 27.53 | 0.6098 |
| 31 | −20.9612 | 1.0000 | 1.88300 | 40.81 | 0.5656 |
| 32 | 25.4542 | 8.3904 | 1.75520 | 27.53 | 0.6098 |
| 33 | −106.2780 | 3.6661 | | | |
| 34 | −33.3334 | 1.0000 | 1.90043 | 37.37 | 0.5767 |
| 35 | −89.4967 | (BF) | | | |
| Image Surface | ∞ | | | | |

[Various Data]

| | INF | 20 m | 3.1 m |
|---|---|---|---|
| Focal Length | 485.01 | 420.05 | 236.23 |
| F-Number | 5.80 | 5.80 | 5.93 |
| Full Angle of | 5.05 | 4.86 | 3.91 |
| View 2ω | | | |
| Image Height Y | 21.63 | 21.63 | 21.63 |
| Total Lens Length | 253.59 | 253.59 | 253.59 |

[Variable Distance Data]

| | INF | 20 m | 3.1 m |
|---|---|---|---|
| d0 | ∞ | 19388.4694 | 2878.0087 |
| d15 | 5.1495 | 7.2432 | 20.5336 |
| d18 | 29.0361 | 26.9423 | 13.6519 |
| BF | 29.8213 | 29.8213 | 29.8213 |

[Lens Group Data]

| Group | Start Surface | Focal Length |
|---|---|---|
| G1 | 1 | 166.46 |
| G2 | 16 | −116.88 |
| G3 | 20 | −61.29 |
| IU | 20 | −40.99 |
| RU | 25 | 62.41 |
| Ln | 34 | −59.49 |
| Fourth Embodiment | | |

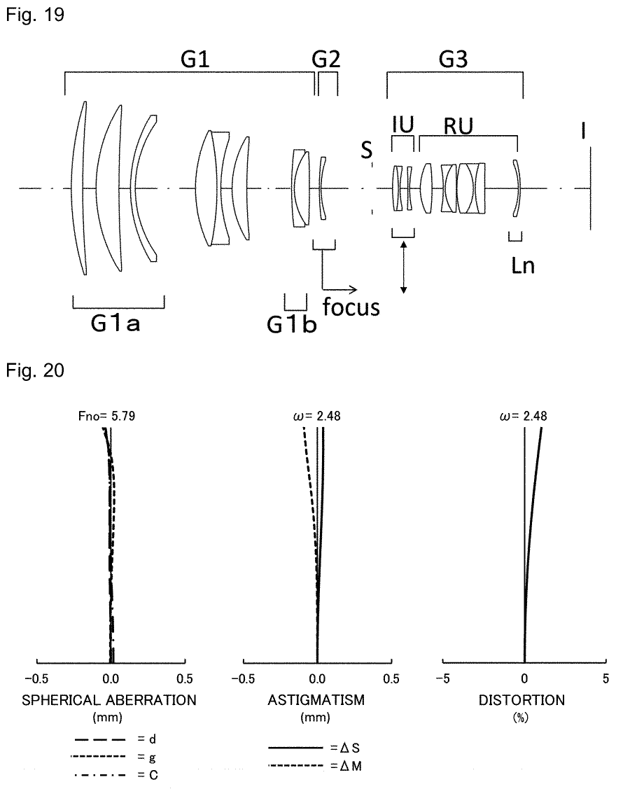

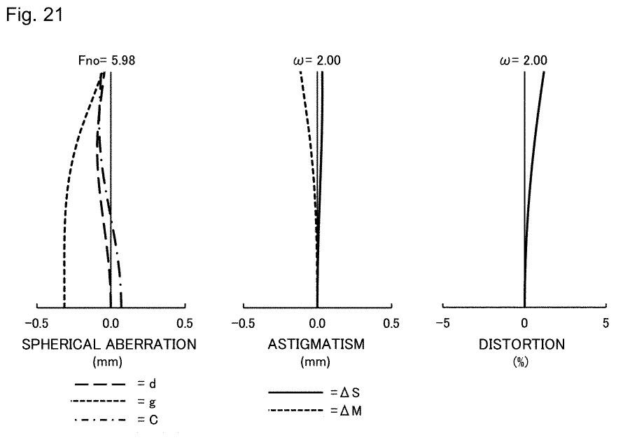

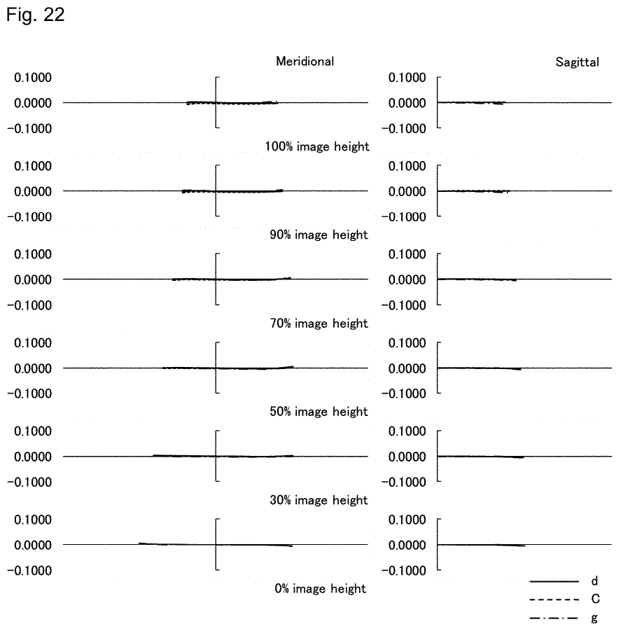

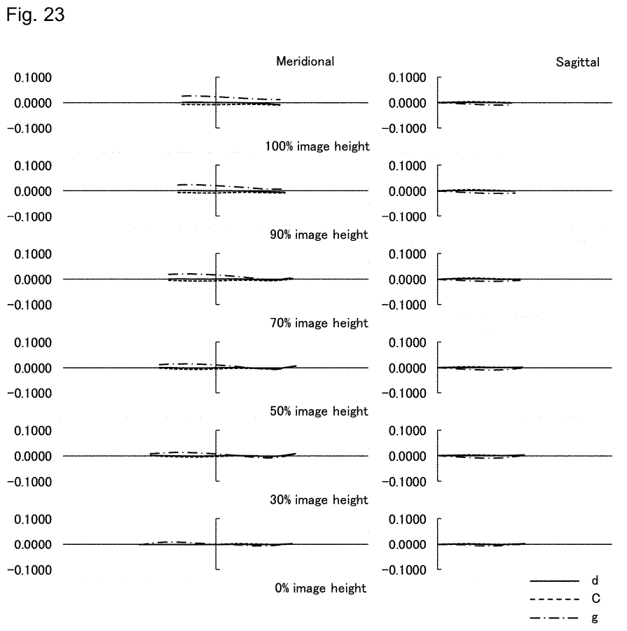

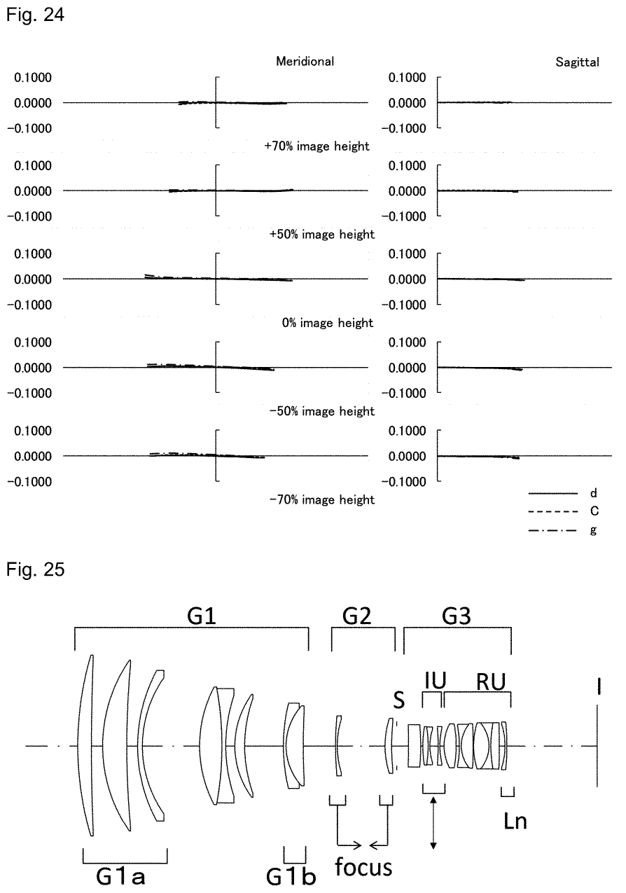

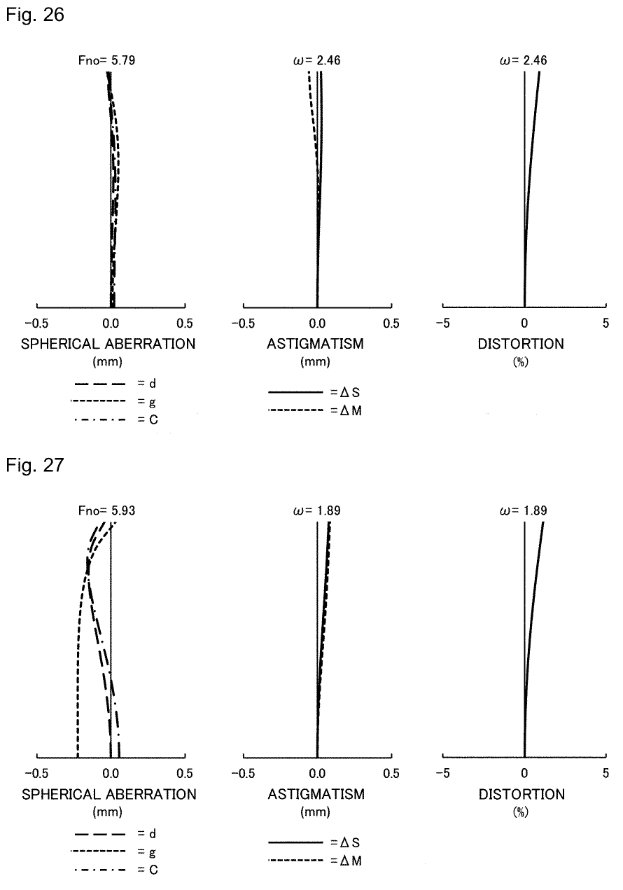

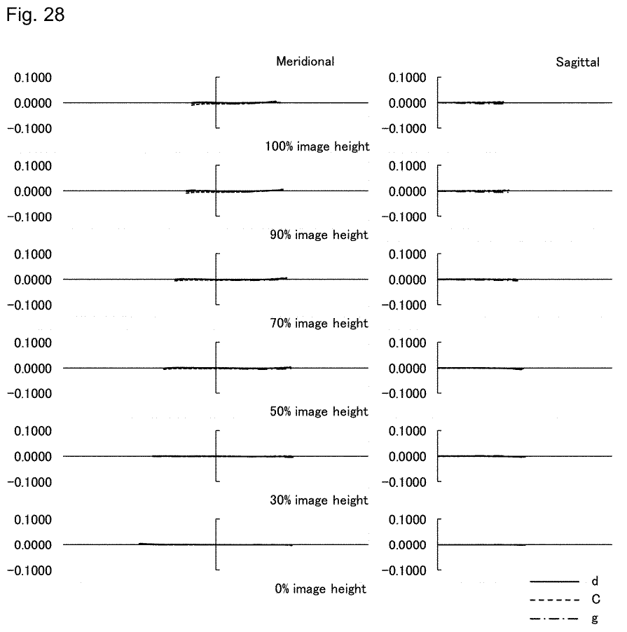

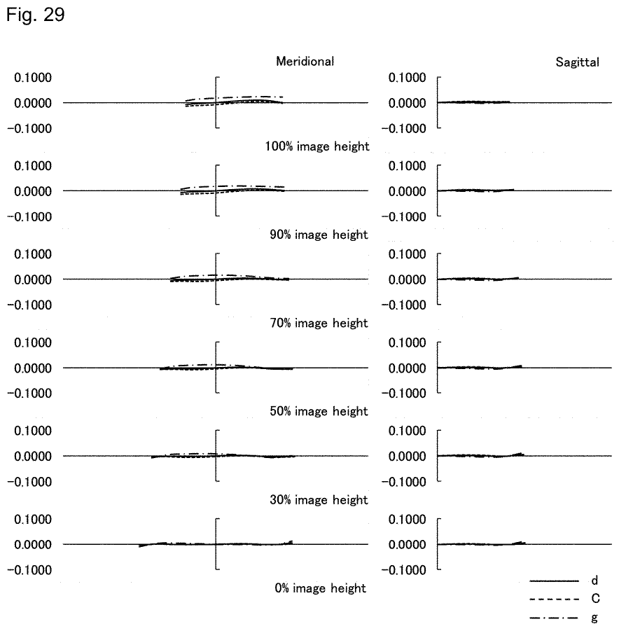

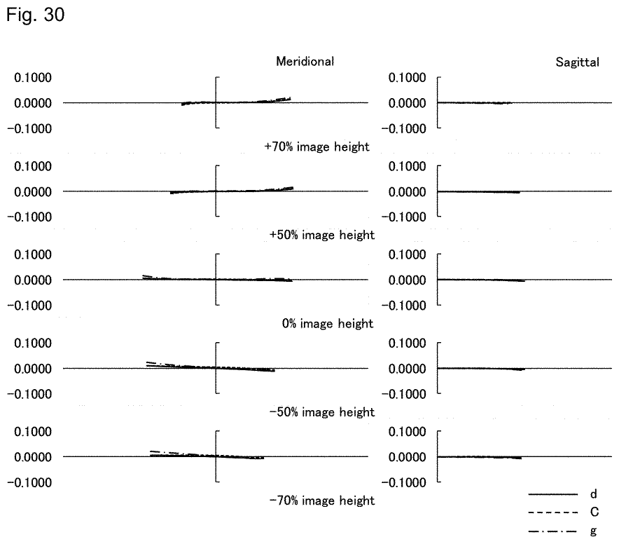

FIG. 19 is the lens configuration diagram of the imaging optical system according to a fourth embodiment of the present invention. The first group G1 is composed of: a meniscus-shaped positive lens L1 with its convex surface facing the object side; a meniscus-shaped positive lens L2 with its convex surface facing the object side; a meniscus-shaped negative lens L3 with its convex surface facing the object side; a cemented lens including a double convex positive lens L4 and a double concave negative lens L5; a meniscus-shaped positive lens L6 with its convex surface facing the object side; and a cemented lens including a meniscus-shaped negative lens L7 with its convex surface facing the object side and a double convex positive lens L8. The first group G1 has positive power overall. Furthermore, the first group G1 is fixed to the image surface at all times. Here, the first a group G1a is composed of the lenses L1, L2, and L3, and the first b group G1b is composed of the lenses L7 and L8.

The second group G2 is composed of a meniscus-shaped negative lens L9 with its convex surface facing the object side and has negative power overall. Furthermore, the second group G2 moves along the optical axis from the object side toward the image side during focusing from an infinite distance object to a close distance object.

The third group G3 is composed of the image blur correction unit IU and the rear unit RU and has negative power overall. Furthermore, the third group G3 is fixed to the image surface during focusing.

The image blur correction unit IU is composed of a cemented lens including a double convex positive lens L10 and a double concave negative lens L11, as well as a double concave negative lens L12. The image blur correction unit IU has negative power overall. Furthermore, the image blur correction unit IU moves in a direction approximately perpendicular to the optical axis to reduce image blur caused by shake in the imaging optical system.

The rear unit RU is composed of: a double convex positive lens L13; a cemented lens including a double concave negative lens L14 and, on the object side, a double convex positive lens L15; a three-element cemented lens including a double convex positive lens L16, a double concave negative lens L17, and a meniscus-shaped positive lens L18 with its convex surface facing the object side; and a meniscus-shaped negative lens L19 with its concave surface facing the object side. The rear unit RU has negative power overall. Furthermore, the rear unit RU is fixed to the image surface at all times.

The aperture diaphragm S is arranged between the second group G2 and the third group G3. The lens component Ln, which is arranged on the most image side within the imaging optical system, is the negative lens L19.

Next, the specification values for the imaging optical system according to the fourth embodiment are provided below.

### Numerical Example 4

Unit: mm
[Surface Data]

| Surface Number | r | d | nd | vd | P_gF |
|---|---|---|---|---|---|
| Object Surface | ∞ | (d0) | | | |
| 1 | 152.6407 | 5.9639 | 1.49700 | 81.61 | 0.5389 |
| 2 | 479.5683 | 6.9529 | | | |
| 3 | 80.8597 | 11.9755 | 1.43700 | 95.10 | 0.5336 |
| 4 | 585.1357 | 6.0275 | | | |
| 5 | 72.6166 | 2.5000 | 1.69680 | 55.46 | 0.5426 |
| 6 | 58.8047 | 31.4706 | | | |
| 7 | 68.7654 | 11.2371 | 1.43700 | 95.10 | 0.5336 |
| 8 | −142.8542 | 2.0000 | 1.77250 | 49.63 | 0.5504 |
| 9 | 77.6483 | 5.8849 | | | |
| 10 | 50.6036 | 7.7034 | 1.43700 | 95.10 | 0.5336 |
| 11 | 255.1568 | 23.4115 | | | |
| 12 | 169.1233 | 1.4000 | 1.88300 | 40.81 | 0.5656 |
| 13 | 31.9189 | 7.9145 | 1.62004 | 36.30 | 0.5873 |
| 14 | −406.6786 | (d14) | | | |
| 15 | 131.6201 | 0.9000 | 1.49700 | 81.61 | 0.5389 |
| 16 | 45.7614 | (d16) | | | |
| 17 (Diaphragm) | ∞ | 10.6662 | | | |
| 18 | 77.1288 | 3.0224 | 1.77047 | 29.74 | 0.5951 |
| 19 | −69.5028 | 0.9000 | 1.59282 | 68.62 | 0.5440 |
| 20 | 47.7243 | 4.0951 | | | |
| 21 | −266.3337 | 0.9000 | 1.88300 | 40.81 | 0.5656 |
| 22 | 50.7912 | 5.5666 | | | |
| 23 | 28.3565 | 6.1268 | 1.67270 | 32.17 | 0.5963 |
| 24 | −106.0047 | 5.8834 | | | |
| 25 | 62.5186 | 1.0000 | 1.94594 | 17.98 | 0.6546 |
| 26 | 21.1671 | 5.8948 | 1.67270 | 32.17 | 0.5963 |
| 27 | −301.0473 | 0.2000 | | | |
| 28 | 48.3691 | 8.6180 | 1.80809 | 22.76 | 0.6287 |
| 29 | −22.9490 | 1.0000 | 1.88300 | 40.81 | 0.5656 |
| 30 | 43.1894 | 4.9693 | 1.75520 | 27.53 | 0.6098 |
| 31 | 674.8222 | 17.5497 | | | |
| 32 | −34.2110 | 1.0000 | 1.90043 | 37.37 | 0.5767 |
| 33 | −54.5225 | (BF) | | | |
| Image Surface | ∞ | | | | |

[Various Data]

| | INF | 20 m | 3.2 m |
|---|---|---|---|
| Focal Length | 494.99 | 436.96 | 259.71 |
| F-Number | 5.79 | 5.79 | 5.98 |
| Full Angle of | 4.95 | 4.80 | 4.00 |
| View 2ω | | | |
| Image Height Y | 21.63 | 21.63 | 21.63 |
| Total Lens Length | 271.35 | 271.35 | 271.35 |

[Variable Distance Data]

| | INF | 20 m | 3.2 m |
|---|---|---|---|
| d0 | ∞ | 19802.1759 | 2952.4687 |
| d14 | 5.1657 | 7.5881 | 22.9611 |
| d16 | 26.7072 | 24.2849 | 8.9118 |
| BF | 36.7468 | 36.7468 | 36.7468 |

[Lens Group Data]

| Group | Start Surface | Focal Length |
|---|---|---|
| G1 | 1 | 178.94 |
| G2 | 15 | − 141.64 |
| G3 | 18 | −76.68 |
| IU | 18 | −50.47 |
| RU | 23 | 63.88 |
| Ln | 32 | −104.42 |
| Fifth Embodiment | | |

FIG. 25 is the lens configuration diagram of the imaging optical system according to a fifth embodiment of the present invention. The first group G1 is composed of: a meniscus-shaped positive lens L1 with its convex surface facing the object side; a meniscus-shaped positive lens L2 with its convex surface facing the object side; a meniscus-shaped negative lens L3 with its convex surface facing the object side; a cemented lens including a double convex positive lens L4 and a double concave negative lens L5; a meniscus-shaped positive lens L6 with its convex surface facing the object side; and a cemented lens including a meniscus-shaped negative lens L7 with its convex surface facing the object side and a meniscus-shaped positive lens L8 with its convex surface facing the object side. The first group G1 has positive power overall. Furthermore, the first group G1 is fixed to the image surface at all times. Here, the first a group G1a is composed of the lenses L1, L2, and L3, and the first b group G1b is composed of the lenses L7 and L8.

The second group G2 is composed of a meniscus-shaped negative lens L9 with its convex surface facing the object side and a meniscus-shaped positive lens L10 with its convex surface facing the object side. The second group G2 has negative power overall. Furthermore, the lens L9 within the second group G2 moves along the optical axis from the object side toward the image side during focusing from an infinite distance object to a close distance object. The lens L10 within the second group G2 moves along the optical axis from the image side toward the object side during focusing from an infinite distance object to a close distance object.

The third group G3 is composed of a lens component, the image blur correction unit IU, and the rear unit RU and has negative power overall. Furthermore, the third group G3 is fixed to the image surface during focusing.

The lens component is composed of a meniscus-shaped positive lens L11 with its concave surface facing the object side.

The image blur correction unit IU is composed of a cemented lens including a double convex positive lens L12 and a double concave negative lens L13, as well as a double concave negative lens L14. The image blur correction unit IU has negative power overall. Furthermore, the image blur correction unit IU moves in a direction approximately perpendicular to the optical axis to reduce image blur caused by shake in the imaging optical system.

The rear unit RU is composed of: a double convex positive lens L15; a cemented lens including a double concave negative lens L16 and, on the object side, a double convex positive lens L17; a three-element cemented lens including a double convex positive lens L18, a double concave negative lens L19, and a double convex positive lens L20; and a meniscus-shaped negative lens L21 with its concave surface facing the object side. The rear unit RU has negative power overall. Furthermore, the rear unit RU is fixed to the image surface at all times.

The aperture diaphragm S is arranged between the second group G2 and the third group G3. The lens component Ln, which is arranged on the most image side within the imaging optical system, is the negative lens L21.

Next, the specification values for the imaging optical system according to the fifth embodiment are provided below.

### Numerical Example 5

Unit: mm
[Surface Data]

| Surface Number | r | d | nd | vd | P_gF |
|---|---|---|---|---|---|
| Object Surface | ∞ | (d0) | | | |
| 1 | 165.9553 | 7.2259 | 1.49700 | 81.61 | 0.5389 |
| 2 | 1118.6991 | 5.9139 | | | |
| 3 | 78.0278 | 12.7478 | 1.43700 | 95.10 | 0.5336 |
| 4 | 454.9471 | 5.7283 | | | |
| 5 | 82.0549 | 2.5000 | 1.69680 | 55.46 | 0.5426 |
| 6 | 61.6396 | 30.2069 | | | |
| 7 | 65.9390 | 11.8209 | 1.43700 | 95.10 | 0.5336 |
| 8 | −166.5051 | 2.0000 | 1.77250 | 49.63 | 0.5504 |
| 9 | 82.4791 | 4.8154 | | | |
| 10 | 45.3814 | 5.1733 | 1.43700 | 95.10 | 0.5336 |
| 11 | 73.3250 | 20.4403 | | | |
| 12 | 93.6788 | 1.4000 | 1.87070 | 40.73 | 0.5682 |
| 13 | 31.0049 | 9.1421 | 1.62004 | 36.30 | 0.5873 |
| 14 | 429.8293 | (d14) | | | |
| 15 | 175.7816 | 0.9000 | 1.49700 | 81.61 | 0.5389 |
| 16 | 47.6860 | (d16) | | | |
| 17 | 46.7191 | 3.4927 | 1.43700 | 95.10 | 0.5336 |
| 18 | 128.7495 | (d18) | | | |
| 19 (Diaphragm) | ∞ | 6.1727 | | | |
| 20 | −479.9920 | 6.4679 | 1.43700 | 95.10 | 0.5336 |
| 21 | −115.9436 | 1.1220 | | | |
| 22 | 67.7872 | 2.8066 | 1.72825 | 28.32 | 0.6075 |
| 23 | −60.9571 | 0.9000 | 1.59282 | 68.62 | 0.5440 |
| 24 | 28.4378 | 4.3934 | | | |
| 25 | −107.6193 | 0.9000 | 1.87070 | 40.73 | 0.5682 |
| 26 | 42.1364 | 2.2000 | | | |
| 27 | 24.7730 | 6.4089 | 1.73037 | 32.23 | 0.5899 |
| 28 | −60.2057 | 1.6700 | | | |
| 29 | −56.4289 | 1.0000 | 1.94594 | 17.98 | 0.6546 |
| 30 | 18.0984 | 6.2978 | 1.67270 | 32.17 | 0.5963 |
| 31 | −213.9943 | 0.2000 | | | |
| 32 | 40.9517 | 8.1326 | 1.80809 | 22.76 | 0.6287 |
| 33 | −18.5101 | 1.0000 | 1.88300 | 40.81 | 0.5656 |
| 34 | 66.1994 | 4.4519 | 1.75211 | 25.05 | 0.6192 |
| 35 | −346.0767 | 3.0030 | | | |
| 36 | −37.3060 | 1.0000 | 1.90043 | 37.37 | 0.5767 |
| 37 | −123.7684 | (BF) | | | |
| Image Surface | ∞ | | | | |

[Various Data]

| | INF | 20 m | 3.3 m |
|---|---|---|---|
| Focal Length | 499.98 | 442.50 | 265.66 |
| F-Number | 5.79 | 5.79 | 5.93 |
| Full Angle of | 4.91 | 4.73 | 3.77 |
| View 2ω | | | |
| Image Height Y | 21.63 | 21.63 | 21.63 |
| Total Lens Length | 274.28 | 274.28 | 274.28 |

[Variable Distance Data]

| | INF | 20 m | 3.3 m |
|---|---|---|---|
| d0 | ∞ | 19999.9799 | 3016.4353 |
| d14 | 17.0185 | 18.9756 | 27.2466 |
| d16 | 25.2166 | 21.9800 | 1.8334 |
| d18 | 2.7269 | 4.0065 | 15.8821 |
| BF | 47.6862 | 47.6863 | 47.6863 |

[Lens Group Data]

| Group | Start Surface | Focal Length |
|---|---|---|
| G1 | 1 | 199.97 |
| G2 | 15 | −2175.01 |
| G3 | 20 | −51.85 |
| IU | 22 | −27.37 |
| RU | 27 | 46.46 |
| Ln | 36 | −59.63 |

Values corresponding to the conditional expressions for each of the above embodiments are provided below.

### Values Corresponding to the Conditional Expressions

| Conditional Expressions | | ex1 | ex2 | ex3 | ex4 | ex5 |
|---|---|---|---|---|---|---|
| 1 | D_A11/D_G1 | 0.28 | 0.27 | 0.27 | 0.25 | 0.25 |
| 2 | (D_A11 + | 0.46 | 0.44 | 0.43 | 0.44 | 0.43 |
| | D_A12)/D_G1 | | | | | |
| 3 | D__G1a/D__G1 | 0.23 | 0.24 | 0.24 | 0.27 | 0.29 |
| 4 | D__A1a \| \|/D__G1 | 0.53 | 0.54 | 0.55 | 0.59 | 0.56 |
| 5 | atan(H_Img/f) | 2.55 | 2.45 | 2.55 | 2.50 | 2.48 |
| 6 | LT/f | 0.52 | 0.52 | 0.52 | 0.55 | 0.55 |
| 7 | Φ__G2G3/Φ | −13.30 | −10.53 | −16.83 | −13.59 | −11.77 |
| 8 | D__EXP/h_img | 3.41 | 4.02 | 2.93 | 3.48 | 3.47 |
| 9 | Φ__G3/Φ | −6.21 | −4.94 | −7.91 | −6.46 | −9.64 |
| 10 | \| Φ__OS/Φ \| | 10.90 | 9.59 | 11.83 | 9.81 | 18.27 |
| 11 | Φ__G2/Φ | −3.83 | −3.48 | −4.15 | −3.49 | −0.23 |
| 12 | v_d | 17.98 | 20.88 | 17.98 | 17.98 | 17.98 |
| 13 | P_g, F + | 0.039 | 0.028 | 0.039 | 0.039 | 0.039 |
| | 0.0018*v_ d · 0.6483 | | | | | |

### Other Embodiments

The technology disclosed herein is not limited to the descriptions of the above embodiments and examples but may be modified and implemented in various ways. The shapes and numerical values of the components indicated in the above numerical examples are examples only for implementing the present technology and are not intended to limit the interpretation of the technical scope of the present technology.

The present technology may also employ the following configurations.

### [Item 1]

An imaging optical system including, in order from an object side to an image side:
a first group G1 with positive power overall;
a second group G2 composed of a lens that moves along an optical axis during focusing; and
a third group G3 with power, wherein
the first group G1 is composed, in order from the object side to the image side, of a first a group G1a, a plurality of lenses, and a first b group G1b,
the first a group G1a has, in order from the most object side, at least two positive lenses and a meniscus-shaped negative lens with a convex surface thereof facing the object side on the most image side,
the first b group G1b has, on the most object side, a positive lens or a lens component including a positive lens on the most image side within the first group G1,
an air distance D_A11, which is the longest within the first group G1, is provided between the first a group G1a and the first b group G1b, and
the imaging optical system satisfies a following conditional expression:

0.05<D_A11/D_G1<0.44, (1)
where
D_A11 represents the longest air distance within the first group G1, and
D_G1 represents a distance on the optical axis from an object-side lens surface of a lens arranged on the most object side to an image-side lens surface of a lens arranged on the most image side within the first group G1.

### [Item 2]

The imaging optical system according to [Item 1], wherein
the imaging optical system satisfies a following conditional expression:

0.10<(D_A11+D_A12)/D_G1<0.70, (2)
where
D_A11 represents the longest air distance within the first group G1, and
D_A12 represents the second-longest air distance between the first a group G1a and the first b group G1b.

### [Item 3]

The imaging optical system according to [Item 1] or [Item 2], wherein the imaging optical system satisfies a following conditional expression:

0.05<D_G1a/D_G1<0.45, (3)
where
D_G1a represents a length along the optical axis of the first a group G1a, and
D_G1 represents the distance along the optical axis from the object-side lens surface of the lens arranged on the most object side to the image-side lens surface of the lens arranged on the most image side within the first group G1.

### [Item 4]

The imaging optical system according to any of [Item 1] to [Item 3], wherein the imaging optical system satisfies a following conditional expression:

0.15<D_A1all/D_G1<0.75, (4)
where
D_A1all represents a sum of all air distances within the first group G1, and
D_G1 represents the distance along the optical axis from the object-side lens surface of the lens arranged on the most object side to the image-side lens surface of the lens arranged on the most image side within the first group G1.

### [Item 5]

The imaging optical system according to any of [Item 1] to [Item 4], wherein the imaging optical system satisfies a following conditional expression:

a tan(H_Img/f)<7.00°, (5)
where
H_Img represents the maximum image height, and
f represents a focal length of the imaging optical system when focusing on infinity.

### [Item 6]

The imaging optical system according to any of [Item 1] to [Item 5], wherein
the imaging optical system satisfies a following conditional expression:

0.10<LT/f<1.00, (6)
where
LT represents a distance along the optical axis from a surface on the most object side to an image surface when the imaging optical system is focusing on infinity, and
f represents a focal length of the imaging optical system when focusing on infinity.

### [Item 7]

The imaging optical system according to any of [Item 1] to [Item 6], wherein
the first b group G1b is composed of a negative lens and a positive lens, or a positive lens and a negative lens.

### [Item 8]

The imaging optical system according to any of [Item 1] to [Item 7], wherein
the imaging optical system satisfies a following conditional expression:

−60.00<Φ_G2G3/Φ<−3.00, (7)
where
Φ represents power of the imaging optical system when focusing on infinity, and
Φ_G2G3 represents a combined power of the second group G2 and the third group G3 when the imaging optical system is focusing on infinity.

### [Item 9]

The imaging optical system according to any of [Item 1] to [Item 8], wherein
the imaging optical system satisfies a following conditional expression:

1.00<D_EXP/H_Img<11.00, (8)
where
D_EXP represents a distance along the optical axis from an exit pupil to an image surface when the imaging optical system is focusing on infinity, and
H_Img represents the maximum image height.

### [Item 10]

The imaging optical system according to any of [Item 1] to [Item 9], wherein
the imaging optical system satisfies a following conditional expression:

−35.00<Φ_G3/Φ<−1.00, (9)
where
Φ represents power of the imaging optical system when focusing on infinity, and
Φ_G3 represents power of the third group G3.

### [Item 11]

The imaging optical system according to any of [Item 1] to [Item 10], wherein
the third group G3 has an image blur correction unit IU, and
a rear unit RU provided on an image side of the image blur correction unit IU,
the image blur correction unit IU and the rear unit RU have different power signs,
the image blur correction unit IU has at least one positive lens and at least one negative lens, and
the imaging optical system satisfies a following conditional expression:

3.00<|Φ_OS/Φ|<35.00, (10)
where
Φ_OS represents power of the image blur correction unit IU, and
Φ represents power of the imaging optical system when focusing on infinity.

### [Item 12]

The imaging optical system according to any of [Item 1] to [Item 11], wherein
the imaging optical system satisfies a following conditional expression:

−20.00<Φ_G2/Φ<−0.13 (11)
where
Φ_G2 represents power of the second group G2, and
Φ represents power of the imaging optical system when focusing on infinity.

### [Item 13]

The imaging optical system according to any of [Item 1] to [Item 12], wherein
the imaging optical system has an aperture diaphragm S and a negative lens that satisfies following conditional expressions on the image side of the aperture diaphragm S:

10.00<ν_d<30.00; (12)

and

0.020<P_gF+0.0018*ν_d−0.6483<0.080, (13)
where
ν_d represents an Abbe number for a d-line of the negative lens arranged on the image side of the aperture diaphragm S,
P_gF represents a partial dispersion ratio for a g-line and an F-line of the negative lens arranged on the image side of the aperture diaphragm S, and
the partial dispersion ratio P_gF=(ng−nF)/(nF−nC) is defined, where
ng represents a refractive index for the g-line (wavelength λ=435.84 nm),
nF represents a refractive index for the F-line (wavelength λ=486.13 nm), and
nC represents a refractive index for a C-line (wavelength λ=656.27 nm).

### [Item 14]

The imaging optical system according to any of [Item 1] to [Item 13], wherein
object-side surfaces and image-side surfaces of all lenses are formed from a spherical surface or a flat surface.

Persons skilled in the art could conceive various corrections, combinations, sub-combinations, and modifications on the basis of design factors or other factors, all of which are included in the scope of the attached claims or their equivalents as a matter of course.

### REFERENCE SIGNS LIST

G1 First group
G2 Second group
G3 Third group
G1a First a group
G1b First b group
IU Image blur correction unit
RU Rear unit
Ln Lens component arranged on most image side
S Aperture diaphragm
I Image surface

What is claimed is:

1. An imaging optical system comprising, in order from an object side to an image side:
a first group G1 with positive power overall;
a second group G2 composed of a lens that moves along an optical axis during focusing; and
a third group G3 with power, wherein
the first group G1 is composed, in order from the object side to the image side, of a first a group G1a, a plurality of lenses, and a first b group G1b,
the first a group G1a has, in order from the most object side, at least two positive lenses and a meniscus-shaped negative lens with a convex surface thereof facing the object side on the most image side,
the first b group G1b has, on the most object side, a positive lens or a lens component including a positive lens on the most image side within the first group G1,
an air distance D_A11, which is the longest within the first group G1, is provided between the first a group G1a and the first b group G1b, and
the imaging optical system satisfies a following conditional expression:
0.05<D_A11/D_G1<0.44, (1)
where
D_A11 represents the longest air distance within the first group G1, and
D_G1 represents a distance on the optical axis from an object-side lens surface of a lens arranged on the most object side to an image-side lens surface of a lens arranged on the most image side within the first group G1.

2. The imaging optical system according to claim 1, wherein
the imaging optical system satisfies a following conditional expression:
0.10<(D_A11+D_A12)/D_G1<0.70, (2)
where
D_A11 represents the longest air distance within the first group G1, and
D_A12 represents the second-longest air distance between the first a group G1a and the first b group G1b.

3. The imaging optical system according to claim 1, wherein
the imaging optical system satisfies a following conditional expression:
0.05<D_G1a/D_G1<0.45, (3)
where
D_G1a represents a length along the optical axis of the first a group G1a, and
D_G1 represents the distance along the optical axis from the object-side lens surface of the lens arranged on the most object side to the image-side lens surface of the lens arranged on the most image side within the first group G1.

4. The imaging optical system according to claim 1, wherein
the imaging optical system satisfies a following conditional expression:
0.15<D_A1all/D_G1<0.75, (4)
where
D_A1all represents a sum of all air distances within the first group G1, and
D_G1 represents the distance along the optical axis from the object-side lens surface of the lens arranged on the most object side to the image-side lens surface of the lens arranged on the most image side within the first group G1.

5. The imaging optical system according to claim 1, wherein
the imaging optical system satisfies a following conditional expression:
a tan(H_Img/f)<7.00°, (5)
where
H_Img represents the maximum image height, and
f represents a focal length of the imaging optical system when focusing on infinity.

6. The imaging optical system according to claim 1, wherein
the imaging optical system satisfies a following conditional expression:
0.10<LT/f<1.00, (6)
where
LT represents a distance along the optical axis from a surface on the most object side to an image surface when the imaging optical system is focusing on infinity, and
f represents a focal length of the imaging optical system when focusing on infinity.

7. The imaging optical system according to claim 1, wherein
the first b group G1b is composed of a negative lens and a positive lens, or a positive lens and a negative lens.

8. The imaging optical system according to claim 1, wherein
the imaging optical system satisfies a following conditional expression:
−60.00<Φ_G2G3/Φ<−3.00, (7)
where
Φ_G2G3 represents a combined power of the second group G2 and the third group G3 when the imaging optical system is focusing on infinity, and
Φ represents power of the imaging optical system when focusing on infinity.

9. The imaging optical system according to claim 1, wherein
the imaging optical system satisfies a following conditional expression:
1.00<D_EXP/H_Img<11.00, (8)
where
D_EXP represents a distance along the optical axis from an exit pupil to an image surface when the imaging optical system is focusing on infinity, and
H_Img represents the maximum image height.

10. The imaging optical system according to claim 1, wherein
the imaging optical system satisfies a following conditional expression:
−35.00<Φ_G3/Φ<−1.00, (9)
where
Φ_G3 represents power of the third group G3, and
Φ represents power of the imaging optical system when focusing on infinity.

11. The imaging optical system according to claim 1, wherein
the third group G3 has an image blur correction unit IU, and a rear unit RU provided on an image side of the image blur correction unit IU,
the image blur correction unit IU and the rear unit RU have different power signs,
the image blur correction unit IU has at least one positive lens and at least one negative lens, and
the imaging optical system satisfies a following conditional expression:
3.00<|Φ_OS/Φ|<35.00, (10)
where
Φ_OS represents power of the image blur correction unit, and
Φ represents power of the imaging optical system when focusing on infinity.

12. The imaging optical system according to claim 1, wherein
the imaging optical system satisfies a following conditional expression:
−20.00<Φ_G2/Φ<−0.13 (11)
where
Φ_G2 represents power of the second group G2, and
Φ represents power of the imaging optical system when focusing on infinity.

13. The imaging optical system according to claim 1, wherein
the imaging optical system has an aperture diaphragm S and a negative lens that satisfies following conditional expressions on the image side of the aperture diaphragm S:
10.00<ν_d<30.00; (12)
and
0.020<P_gF+0.0018*ν_d−0.6483<0.080, (13)
where
ν_d represents an Abbe number for a d-line of the negative lens arranged on the image side of the aperture diaphragm S,
P_gF represents a partial dispersion ratio for a g-line and an F-line of the negative lens arranged on the image side of the aperture diaphragm S, and
the partial dispersion ratio P_gF=(ng−nF)/(nF−nC) is specified,
where
ng represents a refractive index for the g-line (wavelength λ=435.84 nm),
nF represents a refractive index for the F-line (wavelength λ=486.13 nm), and
nC represents a refractive index for a C-line (wavelength λ=656.27 nm).

14. The imaging optical system according to claim 1, wherein
object-side surfaces and image-side surfaces of all lenses are formed from a spherical surface or a flat surface.
